SEQUENCE LISTING (5 sequences)

SEQ ID NO: 1 - protein, 11 aa, synthetic construct
  MOD_RES 11: note = tetramethylrhodamine label
CKVPRNQDWLK

SEQ ID NO: 2 - DNA, 25 bp, synthetic construct
  source 1..25: mol_type = other DNA
  modified_base 25: mod_base = OTHER; note = thiol
tcaactattcctacctacaaaaaaa

SEQ ID NO: 3 - DNA, 25 bp, synthetic construct
  source 1..25: mol_type = other DNA
  modified_base 25: mod_base = OTHER; note = thiol
tccactcatactcagcaaaaaaaaa

SEQ ID NO: 4 - DNA, 25 bp, synthetic construct
  source 1..25: mol_type = other DNA
gtaggtaggaatagttgaattcctt

SEQ ID NO: 5 - DNA, 25 bp, synthetic construct
  source 1..25: mol_type = other DNA
ttgctgagtatgagtggaaaaggaa

(19) United States
(12) Patent Application Publication
(10) Pub. No.: US 2026/0250524 A1
(43) Pub. Date: Aug. 27, 2026

(54) METAL-PHENOLIC NANOPATTERNS AND METHODS OF MAKING AND USING THE SAME

(71) Applicant: NORTHWESTERN UNIVERSITY, EVANSTON, IL (US)

(72) Inventors: Chad A. Mirkin, Wilmette, IL (US); Chaojian Chen, Evanston, IL (US); Millicent Lin, Evanston, IL (US)

(21) Appl. No.: 19/160,328

(22) PCT Filed: Feb. 27, 2024
(86) PCT No.: PCT/US24/17414

§ 371 Date: Aug. 27, 2025

Related U.S. Application Data
(60) Provisional application No. 63/487,603, filed on Feb. 28, 2023.

(51) Int. Cl. C09D 7/61; C09D 11/03

(52) U.S. Cl. CPC C09D 7/61; C09D 11/03

(57) ABSTRACT

A method for patterning metal-phenolic networks on a substrate can include patterning a precursor ink on the substrate, wherein the precursor ink comprising one or more polyphenols and one or more metal ions to form a pattern of discrete precursor features; and exposing the pattern of discrete precursor features to a vapor from a volatile base to thereby convert the discrete precursor features to a pattern of discrete metal-phenolic network features.

### CROSS-REFERENCE TO RELATED APPLICATION

The benefit of priority to U.S. Provisional Patent Application No. 63/487,603 filed Feb. 28, 2023, is hereby claimed and the disclosure is incorporated herein by reference in its entirety.

### STATEMENT OF GOVERNMENT SUPPORT

This invention was made with support under grant FA9550-16-1-0150 awarded by the Air Force Office of Scientific Research. The government has certain rights in the invention.

### INCORPORATION BY REFERENCE OF THE SEQUENCE LISTING

This application contains, as a separate part of the disclosure, a Sequence Listing in computer-readable form (Filename: 2022-206_SeqListing.xml; Size: 6,554 bytes; Created: Feb. 26, 2024) which is incorporated by reference herein in its entirety.

### FIELD

The disclosure relates to metal-phenolic complexes, methods of making metal-phenolic nanopatterns and methods of using the same.

### BACKGROUND

Nanopatterned surfaces with tunable feature dimensions and physicochemical and biological properties are useful in many fields, such as plasmonics, catalysis, and molecular diagnostics. For example, nanoscale structures on solid surfaces have been used to manipulate wettability, leading to materials with superhydrophobic or superhydrophilic features. Moreover, surfaces patterned with biomolecules (e.g., peptides, proteins, DNA) are important not only for investigating fundamental biological processes, but also for fabricating biosensors and optoelectronic devices. From chemical functionality standpoints, generally constructive bottom-up approaches based upon self-assembled monolayers (SAMs) and polymer brushes are more attractive than destructive techniques that require additional steps to achieve targeted outcomes. However, these methods often are either only applicable to specific substrates or produce surfaces with limited functionality, precluding their use as general synthetic platforms.

Polyphenols, ubiquitous compounds often found in plant species, have gained widespread interest in materials science due to their unique physicochemical properties (e.g., pH-responsiveness, metal chelation) and promising biological activity. Because they can interact with materials through multiple types of covalent and noncovalent interactions, polyphenols have been used as versatile coating materials for surface functionalization. In particular, the coordination chemistry between phenolic molecules and metal ions has been employed to design dynamic, pH-responsive metal-phenolic networks (MPNs), which can be deposited on a wide range of substrates, including planar and particulate polymer templates, inorganic nanoparticles and nanowires, mesoporous particles, proteins, and live cells. They have been used for controlling wettability, modular assembly, uranium extraction, biomolecule encapsulation, facilitating cell apoptosis, and bioimaging. However, most MPNs are made by immersing the object of interest in a solution of precursors with network formation occurring en masse and typically taking only a few seconds to minutes. Therefore, using MPNs as inks in constructive lithographic processes is challenging. Indeed, separating the patterning and cross-linking steps is essential to broadly use such materials for lithographic purposes.

Dip-pen nanolithography (DPN) and polymer pen lithography (PPL) are tip-directed patterning/synthesis techniques that can be used to directly write micro- and nanofeatures on surfaces. Over the past two decades, they have proven to be versatile tools for patterning a large number of molecular inks and controlling surface architecture; and more recently, they have opened the door to nanocombinatorics and advanced materials discovery.

### SUMMARY

Disclosed herein is a two-step strategy for using metal-phenolic complexes as precursors in DPN and PPL, which exploit the dynamic coordination chemistry between polyphenols and metal ions. Under acidic conditions, due to weak coordination interactions, metal-phenolic precursors flow and are processed easily. Therefore, they can be used as inks in conventional DPN and PPL. Significantly, the coordination state of the materials that define the patterned features can be adjusted from weak-to-strong states under basic conditions (i.e., ammonia vapor treatment), resulting in more robust features. Structures prepared by methods of the disclosure can be used to: 1) synthesize metal nanostructures of controlled composition and size; and/or 2) immobilize biomolecules (peptides, proteins, and DNA) via post-synthetic modification procedures. Finally, the pH sensitivity of features comprised of these materials can be used to erase and rewrite them based upon intended use. As such, methods and structures of the disclosure can advantageously be used as a multifunctional, and dynamic platform that could prove useful for a wide variety of device applications.

A method for patterning metal-phenolic networks on a substrate in accordance with the disclosure can include patterning a precursor ink on the substrate to form a pattern of discrete precursor features, wherein the precursor ink comprises a polyphenol and one or more metal ions, and the polyphenol has three or more phenolic groups; and exposing the pattern of discrete precursor features to a vapor from a volatile base to thereby convert the pattern of discrete precursor features to a pattern of discrete metal-phenolic network features.

The method can further include functionalizing the pattern of discrete metal-phenolic network features with a biomolecule. For example, the biomolecule can be a peptide, protein, DNA, RNA, and/or oligonucleotide.

A method of forming metal nanostructures in accordance with the disclosure can include patterning a precursor ink on a substrate to form a pattern of discrete precursor features, wherein the precursor ink comprises a polyphenol and one or more metal ions, and the polyphenol has three or more phenolic groups; and annealing the pattern of discrete precursor features in a reducing environment to form the metal nanostructures, wherein the pattern of discrete precursor features is a nanoreactor for the conversion of the metal ions in the precursor ink to the metal nanostructures during annealing.

A method of forming metal nanostructures in accordance with the disclosure can include patterning a precursor ink on a substrate to form a pattern of discrete precursor features, wherein the precursor ink comprises a polyphenol and one or more metal ions, and the polyphenol has 3 or more phenolic groups; exposing the pattern of discrete precursor features to a vapor from a volatile base to thereby convert the pattern of discrete precursor features to a pattern of discrete metal-phenolic network features; and immersing the pattern of discrete metal-phenolic network features in a metal-ion solution comprising one or more metal ions, whereby the one or more metal ions in the metal-ion solution is reduced to form the metal nanostructures.

A method of writing and rewriting a surface comprising metal-phenolic network features in accordance with the disclosure can include patterning a first precursor ink on a substrate ions to form a first pattern of discrete precursor features, wherein the precursor ink comprises a polyphenol and one or more metal, and the polyphenol has 3 or more phenolic groups; exposing the first pattern of discrete precursor features to a first vapor from a volatile base to thereby convert the first pattern of discrete precursor features to a first pattern of discrete metal-phenolic network features; exposing the first pattern of discrete metal-phenolic network features to an acid solution to erase the first pattern of discrete metal-phenolic network features; and rewriting the substrate with a second pattern of discrete metal-phenolic network features by repeating the patterning with a second precursor ink to form a second pattern of discrete precursor features and exposing the second pattern of discrete precursor features to a second vapor from a volatile base to thereby convert the second pattern of discrete precursor features to the second pattern of metal-phenolic network features.

### BRIEF DESCRIPTION OF THE DRAWINGS

FIG. 1A is a schematic of tip-directed synthesis showing the nanopatterning of TA-Fe complexes by DPN and the following metal coordination to synthesize TA-Fe networks under ammonia vapor treatment.

FIG. 1B is a dark field optical image of a 11×11 TA-Fe precursor dot array. Scale bar: 10 μm.

FIG. 1C is a dark field optical image of a 11×11 TA-Fe network dot array after treatment with ammonia vapor. Scale bar: 10 μm.

FIG. 1D is an AFM image of a 11×11 TA-Fe network dot array after treatment with ammonia vapor, showing corresponding AFM height profiles to the dark field optical image of FIG. 1C. Scale bar: 10 μm.

FIG. 1E is a UV-vis spectra of TA-Fe (0.05 mg mL⁻¹) before and after ammonia treatment for 1 and 30 min, respectively. The inset shows the color and pH changes of the solution under ammonia vapor for 30 min.

FIG. 1F is a Raman spectra for TA-Fe network and precursor nanopatterns, as well as an unpatterned area.

FIG. 1G shows STEM images and the corresponding EDS mapping of a single TA-Fe dot showing the distribution of different elements in the network. Scale bars: 100 nm unless otherwise noted.

FIG. 2A includes STEM images and EDS maps showing the tip-directed patterning of TA-based coordination complexes with 17 different metals.

FIG. 2B includes STEM images and EDS maps of TA-based nanopatterns containing two or three metals. From left to right: Co/Ni, Co/Zn, Ni/Zn, and Co/Ni/Zn.

FIG. 2C shows the molecular structures of gallic acid (GA), epicatechin gallate (ECG), and epigallocatechin gallate (EGCG).

FIG. 2D includes STEM images and EDS maps of nanopatterns based on GA, ECG, or EGCG and the metal ion indicated.

FIG. 2E shows molecular structures of epicatechin (EC) and epigallocatechin (EGC), which are the other two dominant polyphenols in addition to ECG and EGCG in green tea. The inset photo shows the tea tree from which the leaves were collected for preparing green tea-based inks.

FIG. 2F is an AFM image of a “TEA” nanopattern obtained by DPN patterning of Tea-Co ink and ammonia treatment.

FIG. 2G includes STEM image and corresponding EDS map of a Tea-Co single dot feature. Scale bars: 100 nm unless otherwise noted.

FIG. 3A is a schematic illustration showing how a single array can be used for single nanoparticle synthesis, Ag⁺ reduction, fibronectin immobilization, cell shape engineering, and DNA-mediated assembly.

FIG. 3B is a STEM image of single Cu nanoparticles prepared using a TA:Cu precursor (molar ratio 2:1).

FIG. 3C is a high-resolution STEM image and corresponding EDS map of a single Cu nanoparticle. Scale bars: 20 nm.

FIG. 3D is a graph showing the average diameter of Cu nanoparticles synthesized using a fixed TA concentration (5 mg mL⁻¹) and different TA:Cu molar ratios (2:1, 5:1, 10:1).

FIG. 3E includes STEM images showing the formation of Ag nanostructures after immersion of a TA-Fe nanodot array in silver ammonia solution for 20 min, 1 h, and 24 h. The bottom right shows the corresponding EDS map of the nanostructure formed after 24 h. Scale bars: 100 nm.

FIG. 3F is a fluorescence microscopy image showing the immobilization of fibronectin on TA-Fe nanopatterns, followed by treatment with human anti-fibronectin primary antibody and Alexa Fluor 647 conjugated goat anti-rabbit secondary antibody.

FIG. 3G includes AFM images of TA-Fe nanopatterns of different shapes and sizes (triangle, circle, large and small rectangle) after treatment with ammonia.

FIG. 3H includes representative fluorescence images of cells grown on the TA-Fe nanopatterns in FIG. 3G.

FIG. 3I includes SEM images showing the DNA-mediated and site-specific assembly of SNAs on TA-Fe nanopatterns.

FIG. 4A is a schematic showing the erasing of a pH-responsive TA-Fe network by HCl and rewriting of a TA-Co nanopattern with a different shape.

FIGS. 4B to 4D are dark field optical images showing (B) a 11×11 TA-Fe network dot array on Si, (C) its disassembly of after immersion into a HCl solution (pH=3) for 15 min, and (D) rewriting of a TA-Co hollow square on the same location. Scale bars: 10 μm.

FIGS. 5A and 5B are dark field optical images of 11×11 droplet dot arrays obtained by DPN patterning (using a 1D 12-pen array) of TA-Fe (5 mg/mL) with 1% (v/v) of glycerol.

FIG. 5C is a dark field optical image of the 11×11 dot array after treatment with ammonia vapor. Scale bars: 10 μm.

FIG. 6A is a dark field optical image of an 11×11 droplet dot array obtained by DPN patterning of TA (5 mg/mL) with 1% (v/v) of glycerol.

FIG. 6B is a dark field optical image of the dot array after treatment under ammonia vapor.

FIG. 6C is an AFM image of the NH₃-treated dot array and corresponding height profiles of line 1 and line 2 in the image. Scale bars: 10 μm.

FIG. 7A is a dark field optical image of a 9×9 droplet dot array obtained by DPN patterning of TA-Fe (5 mg/mL) with 1% (v/v) of glycerol. The dwell time was set from 0.01 s to 5 s.

FIG. 7B is a dark field optical image of the dot array after treatment under ammonia vapor.

FIG. 7C is an AFM image of the NH₃-treated dot array and corresponding height profiles of lines 1, 2, and 3 in the image.

FIGS. 7D and 7E are graphs showing the effect of dwell time on the height (D) and diameter (E) of the fabricated nanodots in FIG. 7C. Scale bars: 10 μm.

FIG. 8A is a dark field optical image of a 9×9 droplet dot array obtained by DPN patterning of TA-Fe (5 mg/mL) with 1% (v/v) of glycerol. The z-extension height was set from 0.5 μm to 4.5 μm.

FIG. 8B is a dark field optical image of the dot array after treatment under ammonia vapor.

FIG. 8C is an AFM image of the NH₃-treated dot array and corresponding height profiles of lines 1, 2, 3 in the image.

FIGS. 8D and 8E are graphs showing the effect of z-extension on the height (D) and diameter (E) of the fabricated nanodots in FIG. 8C. Scale bars: 10 μm.

FIGS. 9A and 9B are dark field optical images showing nanodot arrays with a size of 2 cm×2 cm fabricated by PPL patterning of TA-Fe (5 mg/mL) with 1% (v/v) of glycerol. The tip spacing of the PPL pen array used is 150 μm.

FIG. 9C is a dark field optical image of the pattern in A after treatment under ammonia vapor.

FIG. 9D is a representative AFM image of the NH₃-treated dot array in FIG. 9C.

FIG. 10 includes UV-vis spectra of TA (0.05 mg/mL) before NH₃ treatment and after treatment for 1 min and 30 min. The inset images show the color and pH changes of the solution after treatment for 30 min.

FIG. 11A is an XPS spectra of TA samples prepared by drop-casting after treatment with NH₃.

FIG. 11B is an XPS spectra of TA-Fe samples prepared by drop-casting after treatment with NH₃.

FIG. 11C is an image showing the Fe 2p core-level spectrum of the TA-Fe samples, confirming the presence of Fe in TA-Fe patterns.

FIG. 12A is an optical image of a patterned TA-Fe dot array prepared by PPL after NH₃ treatment. The area marked by the yellow square was scanned for Raman data collection.

FIGS. 12B to 12F are Raman spectra of the five spots marked in FIG. 12A, indicating the difference between unpatterned area (B~C) and TA-Fe patterns (D~F). The Raman bands between 1200 to 1600 cm⁻¹ confirm the presence of TA. The peak at 580 cm⁻¹ is attributed to various Fe—O vibration modes, indicating the coordination interactions between Fe and galloyl groups from TA.

FIGS. 12G and 12H are Raman maps of the area marked in FIG. 12A based on peaks at 580 cm⁻¹ (G) and 1488 cm⁻¹ (H), respectively. The maps were collected by scanning 21×21 spots in the corresponding area.

FIG. 121 is the merged map of FIGS. 12G and 12H, showing the colocalization of galloyl-Fe coordination and TA.

FIG. 13A is a dark field optical image of an 11×11 droplet dot array obtained by DPN patterning of TA-Fe (5 mg/mL) with 1% (v/v) of glycerol.

FIG. 13B is a dark field optical image of TA-Fe dot arrays after treatment under ammonia vapor.

FIG. 13C is an ADF-STEM image of TA-Fe dot arrays after treatment under ammonia vapor.

FIG. 13D is an EDS spectrum of a single TA-Fe nanodot showing the presence of C, O and Fe elements in the network. Al and Si signals are from the TEM sample holder and silicon nitride TEM membrane, respectively.

FIG. 14A includes digital photos of TA-based inks complexed with 16 different metal ions at 5 mg mL⁻¹.

FIG. 14B includes digital photos of the diluted TA-based inks (0.05 mg mL⁻¹) before NH₃ treatment (upper) and after treatment for 30 min (lower).

FIGS. 14C to 14E are UV-vis spectra of the solutions before NH₃ treatment (C) and after treatment for 1 min (D) and 30 min (E).

FIGS. 15A to 15P are dark field optical (left: before NH₃ treatment; middle: after NH₃ treatment) and ADF-STEM (right: after NH₃ treatment) images of TA-based nanodot arrays containing different metals: (A) Co, (B) Ni, (C) Cu, (D) Zn, (E) Al, (F) V, (G) Cr, (H) Mn, (I) Cd, (J) Gd, (K) Tb, (L) Ce, (M) Eu, (N) Mo, (O) Rh, (P) Ru.

FIGS. 16A to 16H are EDS spectra of TA-based nanopatterns after treatment with NH₃ containing different metals: (A) Co, (B) Ni, (C) Cu, (D) Zn, (E) Al, (F) V, (G) Cr, (H) Mn. For the Cu-containing sample, a Cu-free sample holder was used. For the Al-containing sample, an Al-free sample holder was used. For all other samples, Cu and Al peaks are background signals from the TEM sample holder. Si signal is from the silicon nitride TEM membrane.

FIGS. 17A to 17H are EDS spectra of TA-based nanopatterns after treatment with NH₃ containing different metals: (A) Cd, (B) Gd, (C) Tb, (D) Ce, (E) Eu, (F) Mo, (G) Rh, (H) Ru. Cu and Al peaks are background signals from the TEM sample holder. Si signal is from the silicon nitride TEM membrane.

FIG. 18A is a dark field optical image of an 11×11 droplet dot array obtained by DPN patterning of TA-Co/Ni (5 mg/mL, Co:Ni=1:1) with 1% (v/v) of glycerol.

FIG. 18B is a dark field optical image of TA-Co/Ni dot arrays after treatment under ammonia vapor.

FIG. 18C is an ADF-STEM image of TA-Co/Ni dot arrays after treatment under ammonia vapor.

FIG. 18D is an EDS spectrum of a single TA-Co/Ni nanodot showing the presence of Co and Ni elements in the network. Fe, Cu and Al peaks are background signals from the TEM sample holder. Si signal is from the silicon nitride TEM membrane.

FIG. 19A is a dark field optical image of an 11×11 droplet dot array obtained by DPN patterning of TA-Co/Zn (5 mg/mL, Co:Zn=1:1) with 1% (v/v) of glycerol.

FIG. 19B is a dark field optical image of TA-Co/Zn dot arrays after treatment under ammonia vapor.

FIG. 19C is an ADF-STEM image of TA-Co/Zn dot arrays after treatment under ammonia vapor.

FIG. 19D is an EDS spectrum of a single TA-Co/Zn nanodot showing the presence of Co and Zn elements in the network. Fe, Cu and Al peaks are background signals from the TEM sample holder. Si signal is from the silicon nitride TEM membrane.

FIG. 20A is a dark field optical image of an 11×11 droplet dot array obtained by DPN patterning of TA-Ni/Zn (5 mg/mL, Ni:Zn=1:1) with 1% (v/v) of glycerol.

FIG. 20B is a dark field optical image of TA-Ni/Zn dot arrays after treatment under ammonia vapor.

FIG. 20C is an ADF-STEM image of TA-Ni/Zn dot arrays after treatment under ammonia vapor.

FIG. 20D is an EDS spectrum of a single TA-Ni/Zn nanodot showing the presence of Ni and Zn elements in the network. Fe, Cu and Al peaks are background signals from the TEM sample holder. Si signal is from the silicon nitride TEM membrane.

FIG. 21A is a dark field optical image of an 11×11 droplet dot array obtained by DPN patterning of TA-Co/Ni/Zn (5 mg/mL, Co:Ni:Zn=1:1:1) with 1% (v/v) of glycerol.

FIG. 21B is a dark field optical image of TA-Co/Ni/Zn dot arrays after treatment under ammonia vapor.

FIG. 21C is an ADF-STEM image of TA-Co/Ni/Zn dot arrays after treatment under ammonia vapor.

FIG. 21D is an EDS spectrum of a single TA-Co/Ni/Zn nanodot showing the presence of Co, Ni and Zn elements in the network. Fe, Cu and Al peaks are background signals from the TEM sample holder. Si signal is from the silicon nitride TEM membrane.

FIG. 22A is a dark field optical image of an 11×11 droplet dot array obtained by DPN patterning of GA-Cu (5 mg/mL) with 1% (v/v) of glycerol.

FIG. 22B is a dark field optical image of GA-Cu dot arrays after treatment under ammonia vapor.

FIG. 22C is an ADF-STEM image of GA-Cu dot arrays after treatment under ammonia vapor.

FIG. 22D is an EDS spectrum of a single GA-Cu nanodot showing the presence of Cu element in the network. Al and Si signals are from the TEM sample holder and silicon nitride TEM membrane, respectively.

FIG. 23A is a dark field optical image of an 11×11 droplet dot array obtained by DPN patterning of GA-Co (5 mg/mL) with 1% (v/v) of glycerol.

FIG. 23B is a dark field optical image of GA-Co dot arrays after treatment under ammonia vapor.

FIG. 23C is an ADF-STEM image of GA-Co dot arrays after treatment under ammonia vapor.

FIG. 23D is an EDS spectrum of a single GA-Co nanodot showing the presence of Co element in the network. Al and Fe signals are from the TEM sample holder. Si signal is from the silicon nitride TEM membrane.

FIG. 24A is a dark field optical image of an 11×11 droplet dot array obtained by DPN patterning of ECG-Cu (0.5 mg/mL) with 1% (v/v) of glycerol.

FIG. 24B is a dark field optical image of ECG-Cu dot arrays after treatment under ammonia vapor.

FIG. 24C is an ADF-STEM image of ECG-Cu dot arrays after treatment under ammonia vapor.

FIG. 24D is an EDS spectrum of a single ECG-Cu nanodot showing the presence of Cu element in the network. Al and Si signals are from the TEM sample holder and silicon nitride TEM membrane, respectively.

FIG. 25A is a dark field optical image of an 11×11 droplet dot array obtained by DPN patterning of ECG-Ni (0.5 mg/mL) with 1% (v/v) of glycerol.

FIG. 25B is a dark field optical image of ECG-Ni dot arrays after treatment under ammonia vapor.

FIG. 25C is an ADF-STEM image of ECG-Ni dot arrays after treatment under ammonia vapor.

FIG. 25D is an EDS spectrum of a single ECG-Ni nanodot showing the presence of Ni element in the network. Al and Si signals are from the TEM sample holder and silicon nitride TEM membrane, respectively.

FIG. 26A is a dark field optical image of an 8×8 droplet dot array obtained by DPN patterning of EGCG-Co (5 mg/mL) with 1% (v/v) of glycerol.

FIG. 26B is a dark field optical image of EGCG-Co dot arrays after treatment under ammonia vapor.

FIG. 26C is an ADF-STEM image of EGCG-Co dot arrays after treatment under ammonia vapor.

FIG. 26D is an EDS spectrum of a single EGCG-Co nanodot showing the presence of Co element in the network. Al and Si signals are from the TEM sample holder and silicon nitride TEM membrane, respectively.

FIG. 27A is a dark field optical image of an 11×11 droplet dot array obtained by DPN patterning of EGCG-Ni (5 mg/mL) with 1% (v/v) of glycerol.

FIG. 27B is a dark field optical image of EGCG-Ni dot arrays after treatment under ammonia vapor.

FIG. 27C is an ADF-STEM image of EGCG-Ni dot arrays after treatment under ammonia vapor.

FIG. 27D is an EDS spectrum of a single EGCG-Ni nanodot showing the presence of Ni element in the network. Al and Fe signals are from the TEM sample holder. Si signal is from the silicon nitride TEM membrane.

FIG. 28A is a digital photo of the Tea-Co ink.

FIG. 28B is a bitmap image for guiding the DPN writing of a “TEA” pattern, in which the black pixels were set as writing pixels.

FIG. 28C is a dark field optical image of the “TEA” nanopattern obtained by DPN patterning of Tea-Co ink with 1% (v/v) of glycerol.

FIG. 28D is a dark field optical image of the “TEA” nanopattern after treatment under ammonia vapor.

FIG. 28E is a dark field optical image of an 11×11 droplet dot array obtained by DPN patterning of Tea-Co with 1% (v/v) of glycerol.

FIG. 28F is a dark field optical image of Tea-Co dot arrays after treatment under ammonia vapor.

FIG. 28G is an ADF-STEM image of Tea-Co dot arrays after treatment under ammonia vapor.

FIG. 28H is an EDS spectrum of a single Tea-Co nanodot showing the presence of Co element in the network. Al and Si signals are from the TEM sample holder and silicon nitride TEM membrane, respectively.

FIG. 29A is a digital photo of the Tea-Ni ink.

FIG. 29B is the bitmap image for guiding the DPN writing of a “TEA” pattern, in which the black pixels were set as writing pixels.

FIG. 29C is a dark field optical image of the “TEA” nanopattern obtained by DPN patterning of Tea-Ni ink with 1% (v/v) of glycerol.

FIG. 29D is a dark field optical image of the “TEA” nanopattern after treatment under ammonia vapor.

FIG. 29E is an AFM image of the “TEA” nanopattern after treatment under ammonia vapor.

FIG. 29F is a dark field optical image of an 11×11 droplet dot array obtained by DPN patterning of Tea-Ni with 1% (v/v) of glycerol.

FIG. 29G is a dark field optical image of Tea-Ni dot arrays after treatment under ammonia vapor.

FIG. 29H is an AFM image of the “TEA” nanopattern after treatment under ammonia vapor.

FIG. 29I is a STEM image of a single Tea-Ni dot.

FIG. 29J is an EDS map of a single Tea-Ni dot.

FIG. 29K is an EDS spectrum of a single Tea-Ni nanodot showing the presence of Ni element in the network. Al and Si signals are from the TEM sample holder and silicon nitride TEM membrane, respectively.

FIGS. 30A to 30F are STEM images of CuNPs synthesized using different TA:Cu molar ratios: (A and B) 2:1, (C and D) 5:1, (E and F) 10:1.

FIGS. 31A to 31C are STEM images, EDS mapping and spectra of CuNPs synthesized using different TA-Cu molar ratios: (A) 2:1, (B) 5:1, (C) 10:1.

FIG. 32A is a schematic showing the reduction of Ag ions by immersing TA-Fe nanopatterns into silver ammonia solution for different times.

FIGS. 32B to 32D are STEM images of TA-Fe nanopatterns treated with Ag(NH₃)₂OH solution for 20 min, 1 h, and 24 h, respectively.

FIGS. 32E and 32F are (E) EDS mapping and (F) corresponding EDS spectrum for the TA-Fe nanodot treated with Ag(NH₃)₂OH solution for 20 min.

FIG. 33A is a schematic showing the plasma treatment of TA-Fe nanopatterns, followed by EG backfill and peptide attachment.

FIGS. 33B and 33C are immunofluorescent micrographs of TA-Fe network patterns functionalized with TAMRA-labeled peptide CKVPRNQDWL-K (TAMRA) (SEQ ID No. 1). The TA-Fe patterns were printed by PPL.

FIG. 34A is a schematic showing the immobilization of fibronectin onto TA-Fe nanopatterns, followed by the treatment of fibronectin-immobilized patterns by the human anti-fibronectin primary antibody and the Alexa Fluor 488 conjugated goat anti-rabbit secondary antibody.

FIG. 34B is an immunofluorescent image of fluorophore-labeled fibronectin patterns generated by PPL.

FIGS. 35A to 35D are dark field optical images of large-area TA-Fe patterns varied in different shapes enabled by PPL with an applied force of ~1800 mN. (A) Triangle, (B) circle, (C) large rectangle, and (D) small rectangle.

FIG. 36A includes dark field optical images of TA-Fe nanopatterns with different sizes and shapes (triangle, circle, large rectangle, and small rectangle).

FIG. 36B includes AFM images of TA-Fe nanopatterns with different sizes and shapes (triangle, circle, large rectangle, and small rectangle)

FIG. 36C includes representative fluorescent images of non-muscle Myosin IIA and nucleus and the overlapping images within single cells patterned in triangle, circle, large rectangle, and small rectangle shapes. Scale bars: 10 μm.

FIG. 37 is a schematic showing the functionalization of metal-phenolic network nanopatterns with DNA strands and DNA-mediated assembly of SNAs onto the nanopatterns. Top: non-complementary DNA design: substrate (Anchor A and L_{A}) and SNAs (Anchor A and L_{A}); Bottom: Complementary DNA design: substrate (Anchor B and L_{B}) and SNAs (Anchor A and L_{A}). For simplicity, the linker DNA is not illustrated in the scheme.

FIGS. 38A and 38B are XPS spectra confirming the successful attachment of DNA strands A (A) and B (B) to TA-Fe network nanopatterns.

FIG. 39 is an SEM image of SNAs used for DNA-mediated assembly.

FIG. 40A is an optical image showing the site-selective assembly of SNAs on TA-Fe nanopatterns functionalized with the complementary DNA strand B (Anchor B and L_{B}).

FIG. 40B includes AFM images showing the site-selective assembly of SNAs on TA-Fe nanopatterns functionalized with the complementary DNA strand B (Anchor B and L_{B}).

FIG. 40C includes SEM images showing the site-selective assembly of SNAs on TA-Fe nanopatterns functionalized with the complementary DNA strand B (Anchor B and L_{B}).

FIG. 41 includes SEM images showing the non-canonical adsorption of SNAs on TA-Fe nanopatterns functionalized with non-complementary DNA strand A (Anchor A and L_{A}).

### DETAILED DESCRIPTION

Methods of the disclosure can be used for patterning metal-phenolic networks on a substrate. The method can include patterning a precursor ink on the substrate to form a pattern of discrete precursor features and exposing the pattern of discrete precursor features to a vapor from a volatile base to thereby convert the pattern of discrete precursor features to a pattern of discrete metal-phenolic network features. The precursor ink includes (i) a polyphenol having at least 3 phenolic groups and (i) one or more metal ions. For example, the precursor ink can include one or more metal salts as a precursor for supplying the one or more metal ions. The method of can further include functionalizing the pattern of discrete phenolic network features with a biomolecule, such as, but not limited to a peptide, protein, DNA, RNA, and/or oligonucleotides.

Methods of forming metal nanostructures in accordance with the disclosure can include patterning a precursor ink on a substrate to form a pattern of discrete precursor features. The precursor ink includes a polyphenol having at least 3 phenolic groups and further include one or more metal ions. For example, the precursor ink can include one or more metal salts as a precursor for supplying the one or more metal ions. The method further includes annealing the pattern of discrete precursor features in a reducing environment to form the metal nanostructures. The pattern of discrete precursor features functions as a nanoreactor for the conversion of metal ions in the precursor ink to metal nanoparticles.

In such methods of forming nanoparticles, a ratio of polyphenol to metal ion in the precursor ink can be about 1:1 to about 20:1, about 1:5 to about 10:1, about 1:10 to about 20:1, about 1:15 to about 15:1, or any values therebetween or further ranges defined by such values. For example, the ratio can be about 2:1.

Methods of forming metal nanostructures in accordance with the disclosure can alternatively include patterning a precursor ink on a substrate to form a pattern of discrete precursor features. The precursor ink includes a polyphenol having at least 3 phenolic groups and further include one or more metal ions. For example, the precursor ink can include one or more metal salts as a precursor for supplying the one or more metal ions. The pattern can be exposed to vapor from a volatile base to convert the pattern of discrete precursor features to a pattern of discrete metal-phenolic network features. The pattern of discrete metal-phenolic network features can then be immersed in a metal-ion solution comprising one or more metal ions, whereby the one or more metal ions from the metal-ion solution is reduced to form the metal nanostructures. The metal ions in the metal-ion solution can be, for example, one or more of Au³⁺, Ag⁺, and Pd²⁺.

Methods of the disclosure can also be useful in preparing surface capable of being written and rewritten. Such methods can include patterning a precursor ink on a substrate to form a discrete pattern of precursor features. The precursor ink includes a polyphenol having at least 3 phenolic groups and further include one or more metal ions. For example, the precursor ink can include one or more metal salts as a precursor for supplying the one or more metal ions. The method further includes exposing the pattern of discrete precursor features to a vapor from a volatile base to thereby convert the first pattern of discrete precursor features to a first pattern of discrete metal-phenolic network features. The substrate can be erased by exposing the first pattern to an acid solution. Rewriting is then possible by repatterning the substrate with a precursor ink to form a second pattern of discrete precursor features and exposing the second pattern to a vapor from a volatile base to convert the second pattern of discrete precursor features to a second pattern of discrete metal-phenolic network features. The precursor ink used in the first and second patterning steps can be the same or different. The second patterning can include, for example, forming a different pattern of the same features and/or forming a pattern with a different composition, such as a different metal ion. Similarly, the vapor used in the first and second writing steps can be the same or different. Erasing and rewriting of the substrate can be performed any number of times with the same or different precursor inks and vapors.

The acid solution for erasing the substrate can be one or more of HCl, H₂SO₄, HNO₃, and H₂CO₃.

In any of the methods of the disclosure the metal ions can be from a metal selected from one or more of Fe, Co, Ni, Cu, Zn, Al, V, Cr, Mn, Cd, Gd, Tb, Ce, Eu, Mo, Rh, and Ru. The metal ions can be provided as a metal precursor in the precursor ink. For example, the metal precursor can be a metal salt. For example, the metal salt can be FeCl₃, Co(NO₃)₂, NiCl₂, Cu(NO₃)₂, Zn(NO₃)₂, and MnCl₂. These metal salts are by way of example only and the use of other metal salts are contemplated herein. The precursor ink can include a single metal ion or can include mixtures of metal ions. Such metal ions can be provided as a mixture of metal precursors, for example.

The polyphenol includes catechol and/or galloyl groups. Examples of polyphenols can include one or more of tannic acid (TA), gallic acid (GA), epicatechin gallate (ECG), epigallocatechin gallate (EGCG), theaflavin-3′-gallate, and castalagin. The precursor ink can include one or more polyphenols. For example, the precursor ink can include a single polyphenol. For example, the precursor ink can include two or more polyphenols, each with different numbers of catechol and/or galloyl groups.

Substrates patterned by the methods of the disclosure can be hydrophobic and/or can have a hydrophobic coating, layer, or surface.

The vapor for treating the precursor features can be, for example, from one or more of ammonia, hydrazine, methylamine, ethylamine, diethylamine, and triethylamine.

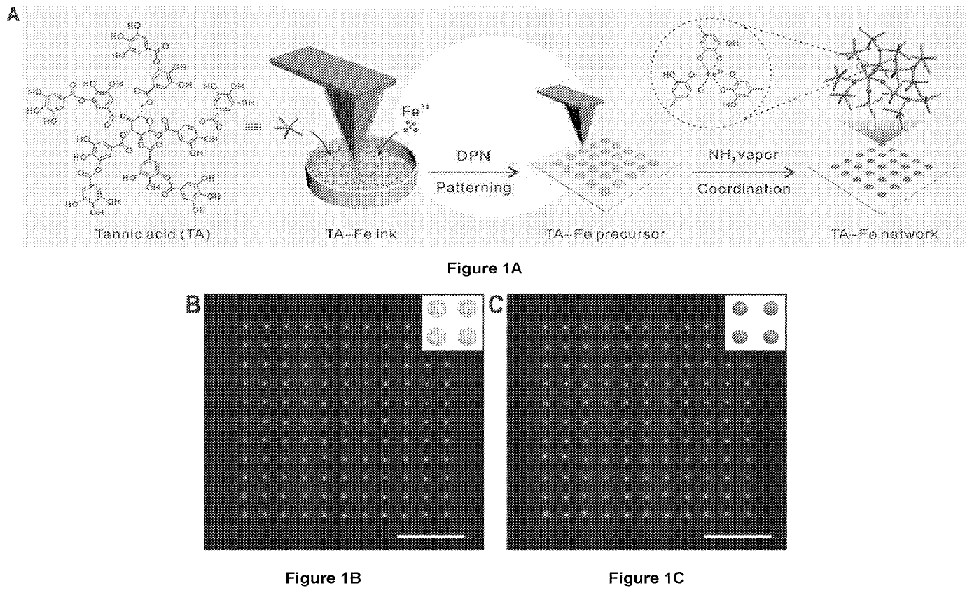

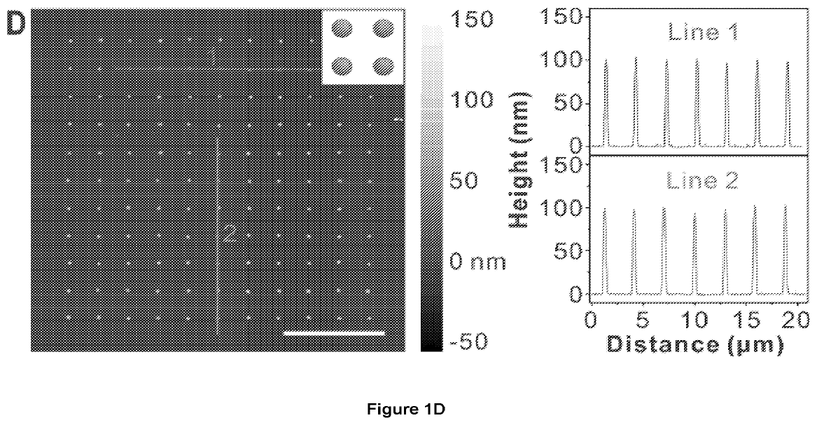

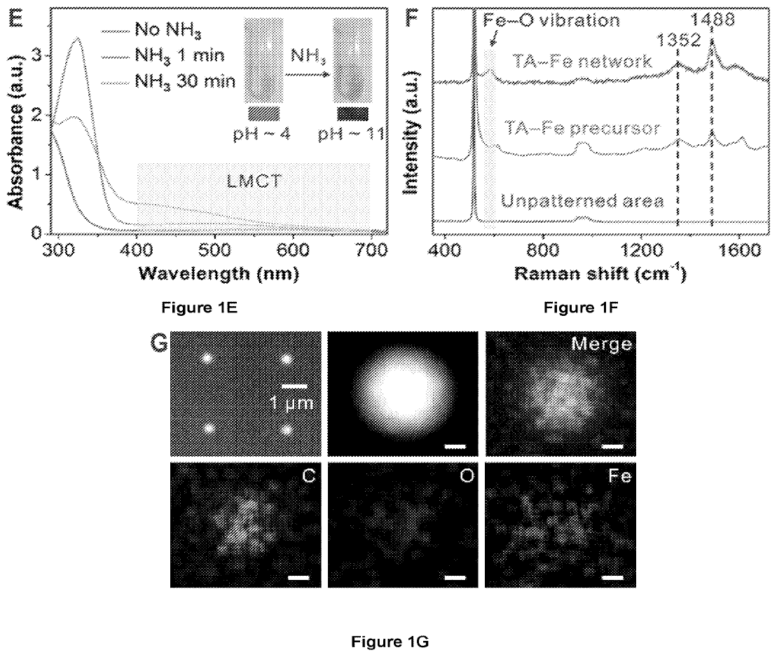

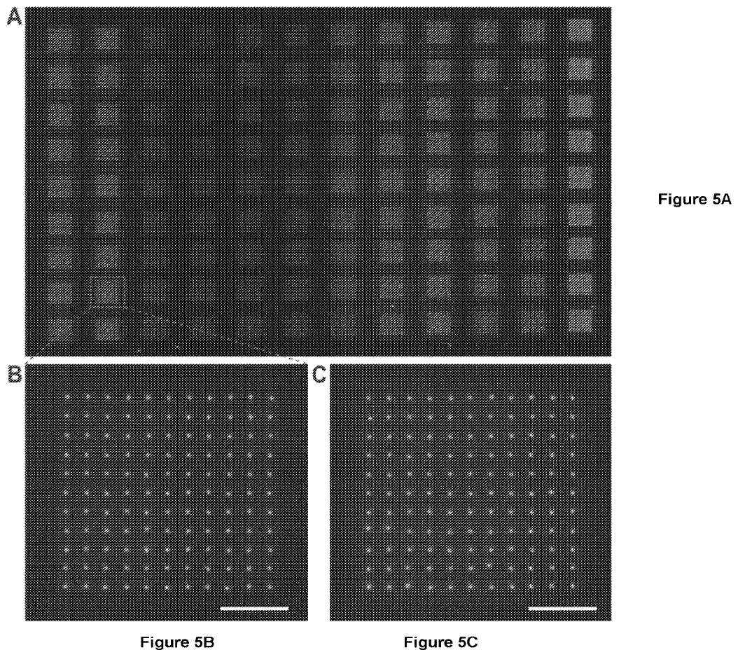

Referring to FIG. 1A, in one example embodiment of the method, tannic acid (TA), a plant-derived polyphenol, was complexed with Fe³⁺ ions. Briefly, TA was first dissolved in distilled water at a concentration of 5 mg mL⁻¹ and then mixed with an equimolar amount of FeCl₃. To optimize flow in a DPN experiment, 1% (v/v) of glycerol was added to increase the ink viscosity. In a typical experiment, a one-dimensional pen array dip-coated with the TA-Fe ink was mounted onto an atomic force microscope (AFM, Park Systems XE-150). DPN was performed by bringing the pen array into contact with a hydrophobic Si substrate at a relative humidity between 80 and 85%. Ammonia has previously been employed to trigger the formation of polydopamine on surfaces. Referring to FIGS. 1B and 5, the as-patterned TA-Fe precursor arrays were treated with ammonia vapor to synthesize uniform TA-Fe network nanodot arrays with heights of ~100 nm (FIG. 1C-1D).

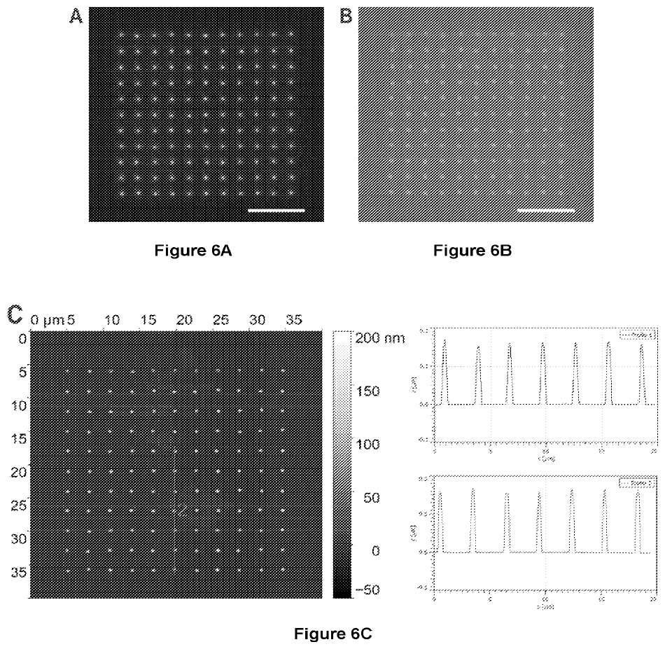

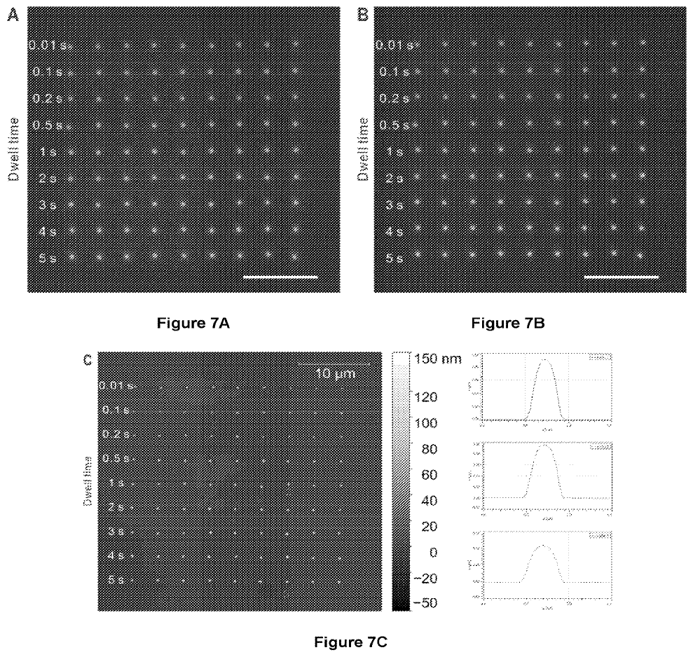

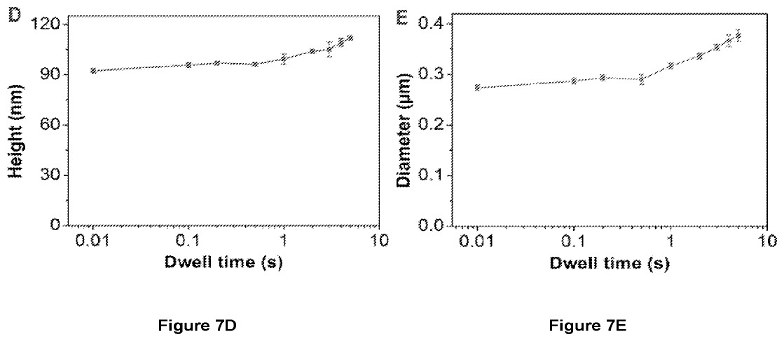

The nanopatterns were observed to be stable even after being repeatedly washed with water. Without intending to be bound by theory, it is believed that the stability is due to the collective multivalent interactions between the crosslinked molecular network and the substrate (e.g., hydrophobic attraction, van der Waals interactions). Referring to FIG. 6, TA-based inks were patterned without metal ions to show a comparison. In the absence of metal-ions, these nanodot arrays were easily washed away after ammonia treatment. The stability of the TA-Fe precursor arrays was evaluated prior to ammonia treatment, and it was observed that the arrays did not survive a water rinsing step. Without intending to be bound by theory, it is believed that both the patterns formed without the metal ion and the patterns with metal ion prior to vapor treatment did not form crosslinked molecular networks. In the absence of crosslinking, nonvalent interactions were too weak to firmly adhere the structures to the surface. This illustrates the significance of the presence of the metal ion in forming stable patterns.

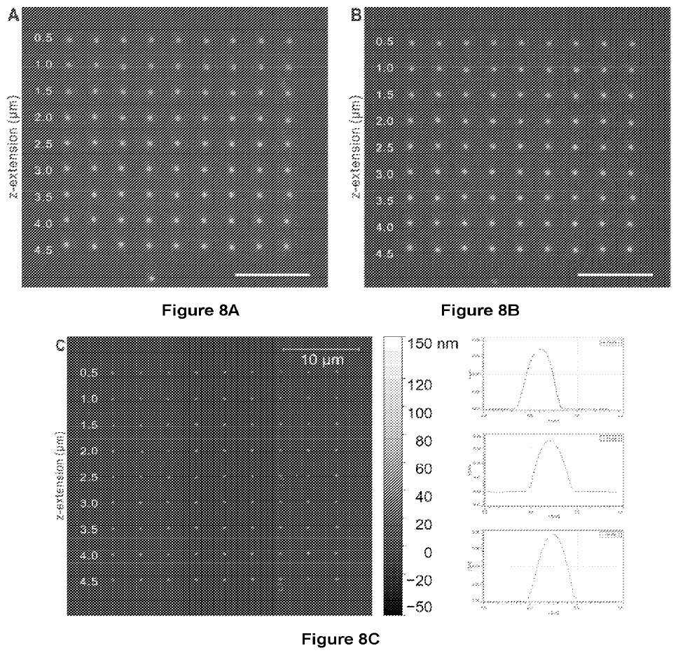

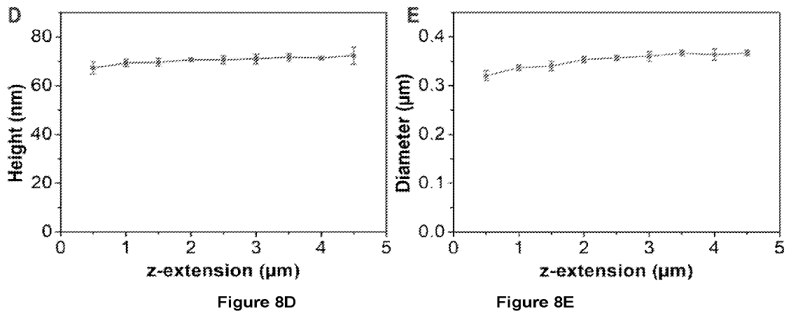

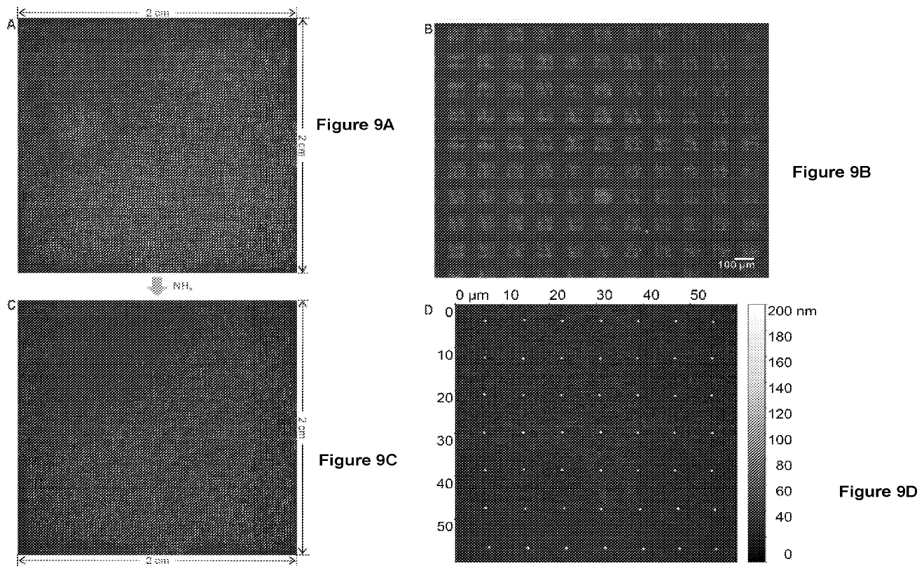

It was also observed that the nanodot size was not significantly impacted by dwell time (FIG. 41) and contact force (z-extension height, FIG. 8), indicating that highly uniform nanopatterns can be synthesized under a wide range of patterning conditions. Unlike DPN, PPL employs a large-scale two-dimensional array of elastomeric pyramidal tips. To demonstrate the broad applicability of this strategy, PPL was utilized to pattern the same ink on Au-coated indium tin oxide glass substrates. Highly uniform nanodot arrays over centimeter-scale areas (4 cm²) were obtained (FIG. 9).

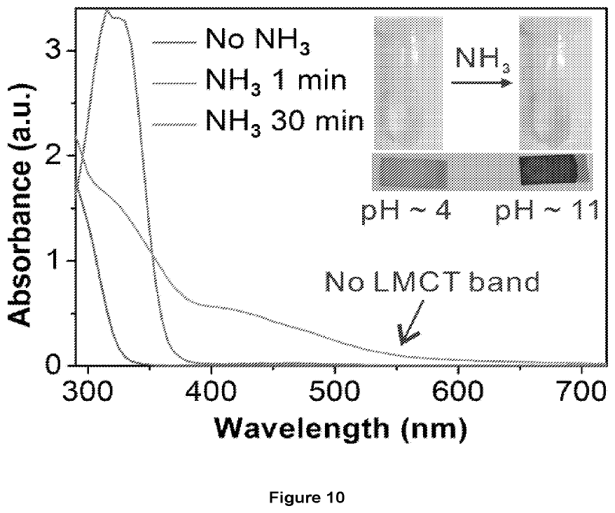

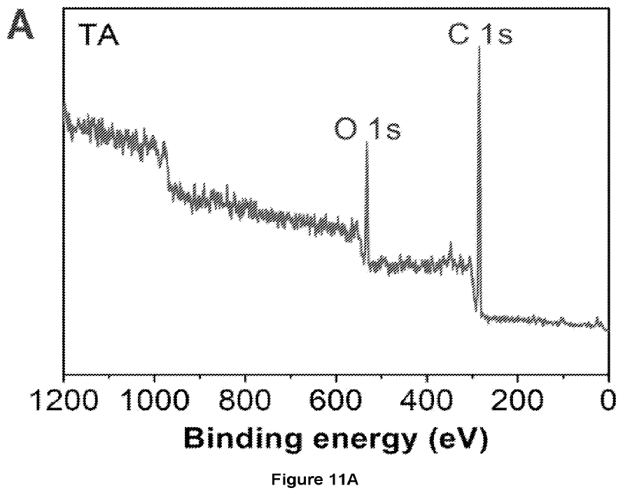

The formation of stable metal-phenolic nanopatterns (MPnPs) under basic conditions (i.e., ammonia vapor) was confirmed using various methods. First, macroscale TA and TA-Fe droplet arrays were prepared in a petri dish and exposed them to ammonia vapor. Color changes were observed in less than 5 min with both inks, indicating a fast, pH-triggered molecular transition. Dilute TA and TA-Fe ink solutions were then characterized using UV-vis spectroscopy before and after treatment. Unlike the TA ink without metal ions (FIG. 10), a characteristic ligand-to-metal charge transfer (LMCT) band was observed for the TA-Fe ink between 400 to 700-nm in the spectrum (FIG. 1E). Additionally, the band signal significantly increased after the ink was treated with ammonia (pH increased from 4 to 11) for 1 min, indicating that the formation of TA-Fe coordination tris-complexes occurred under basic conditions.

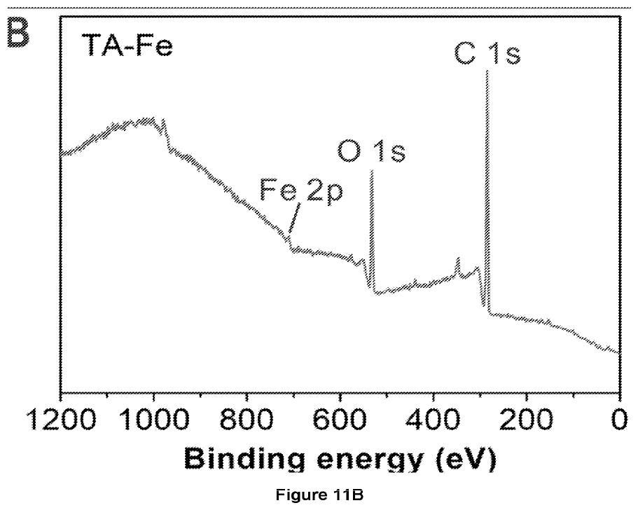

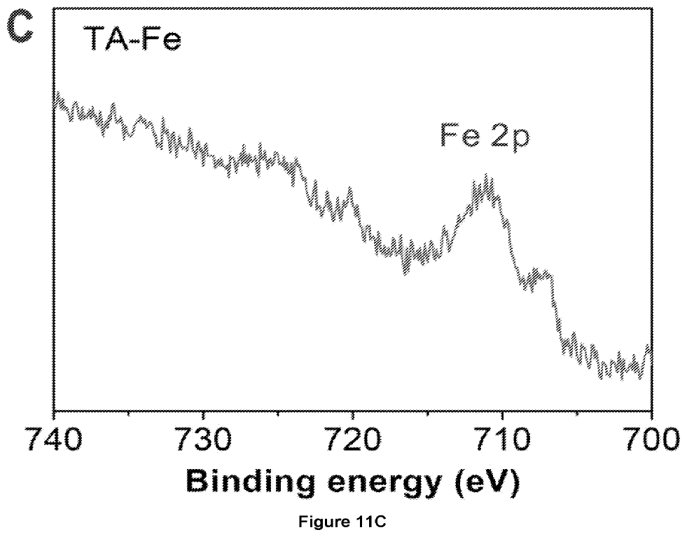

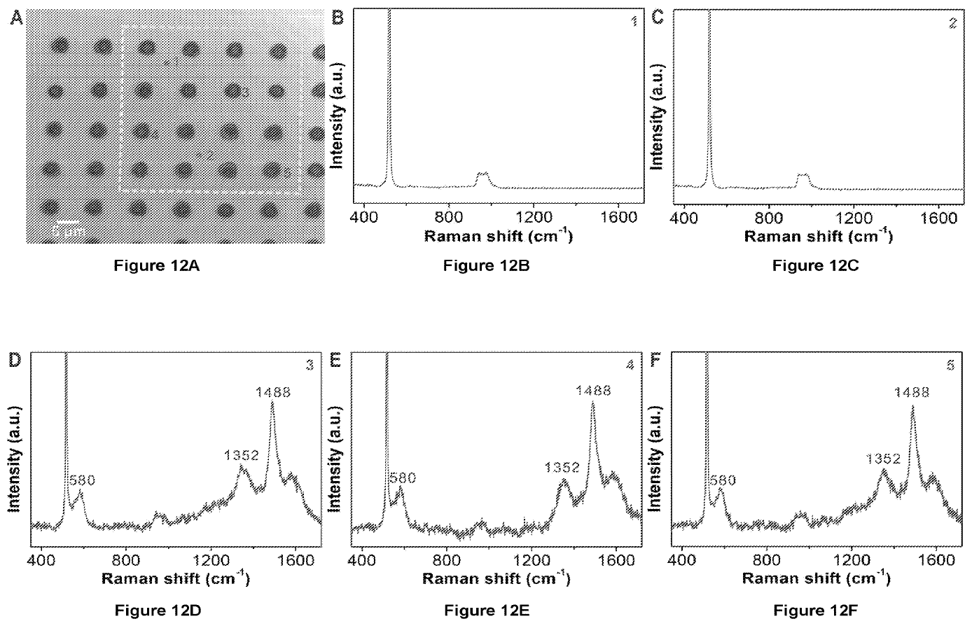

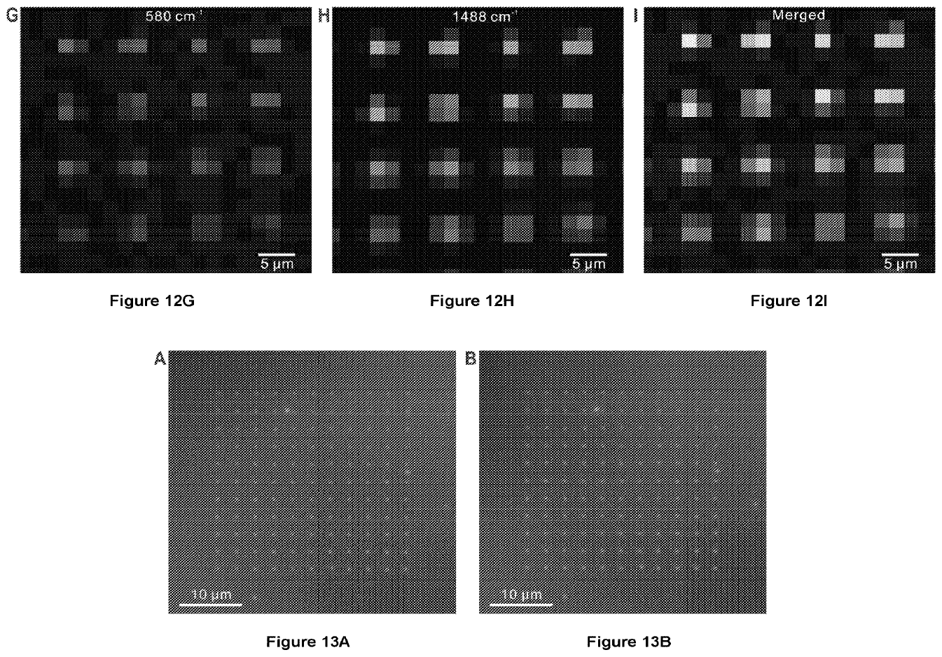

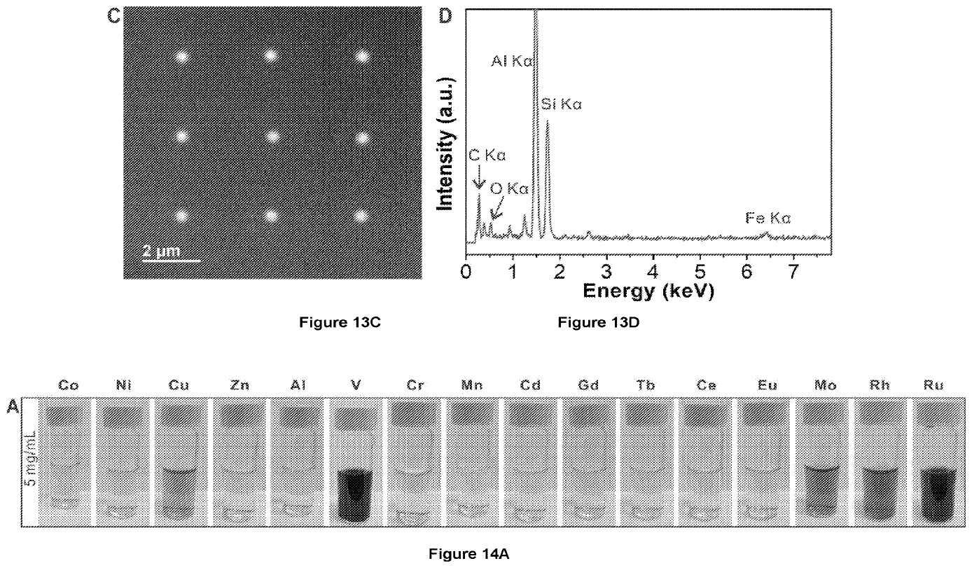

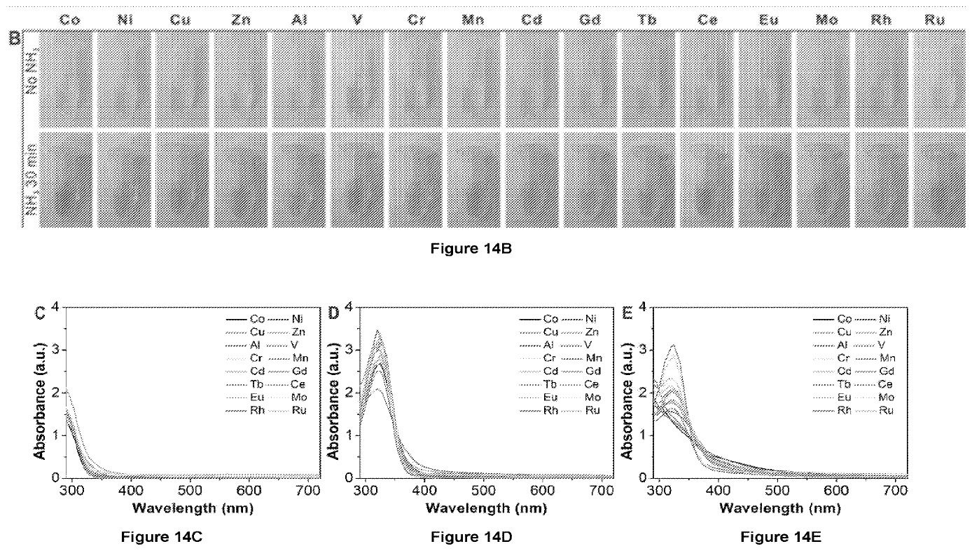

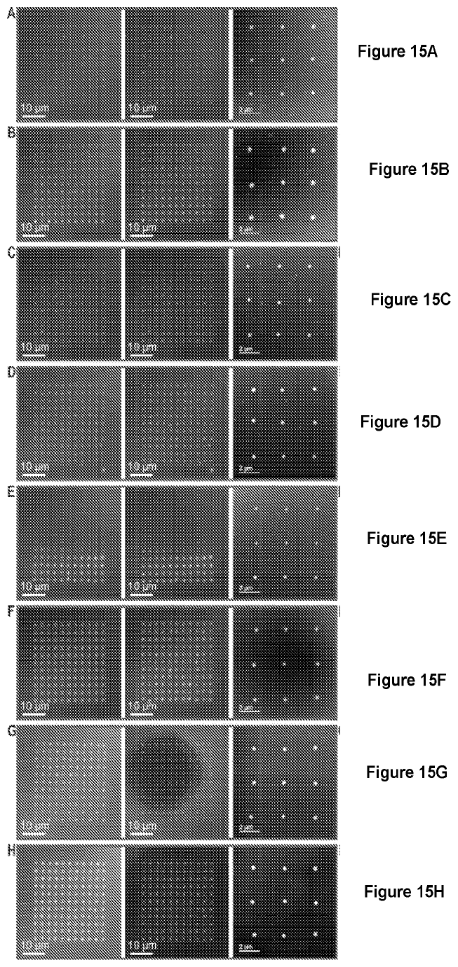

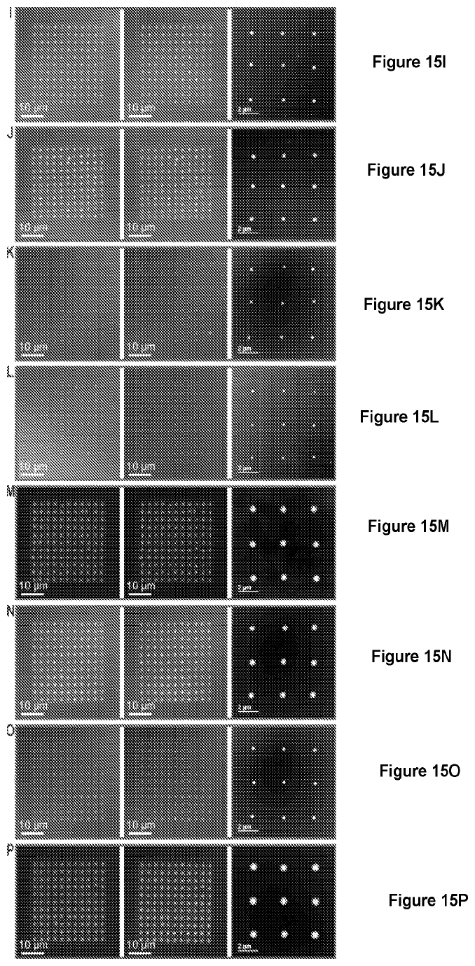

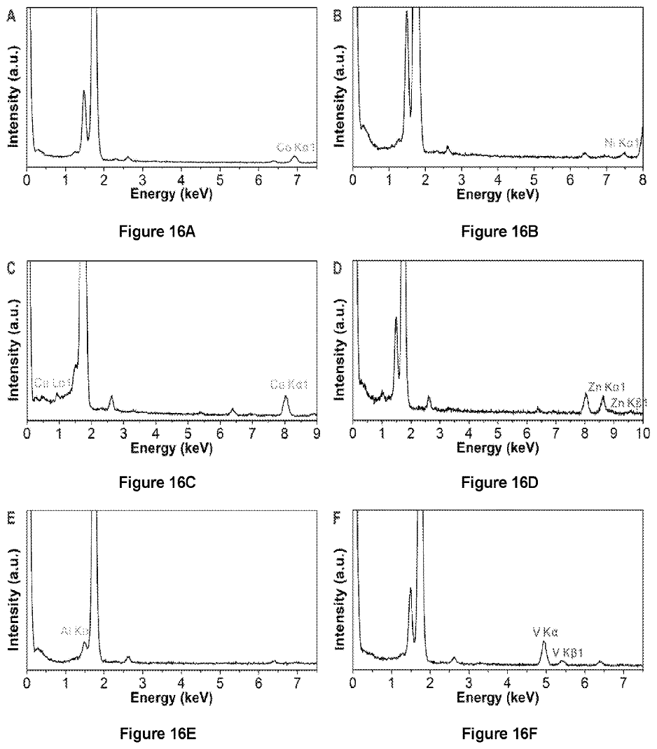

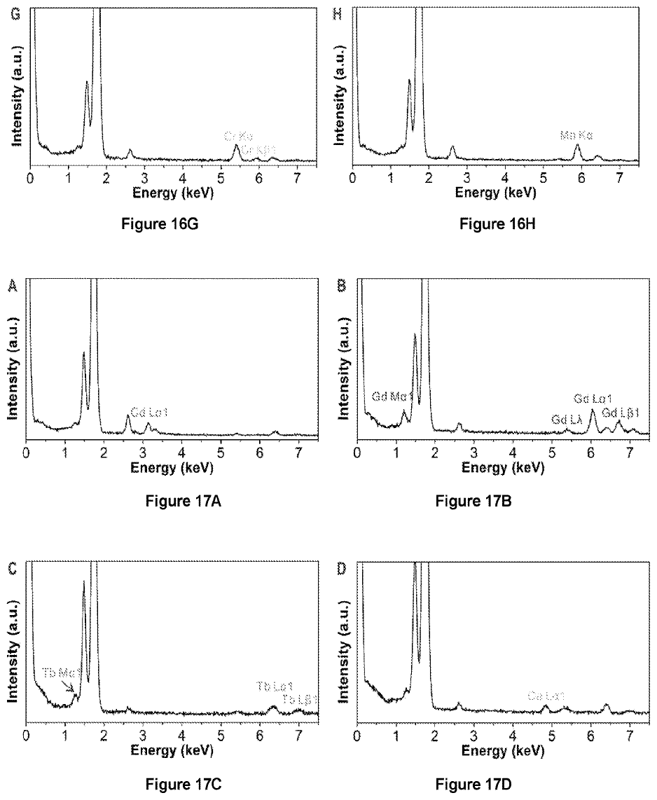

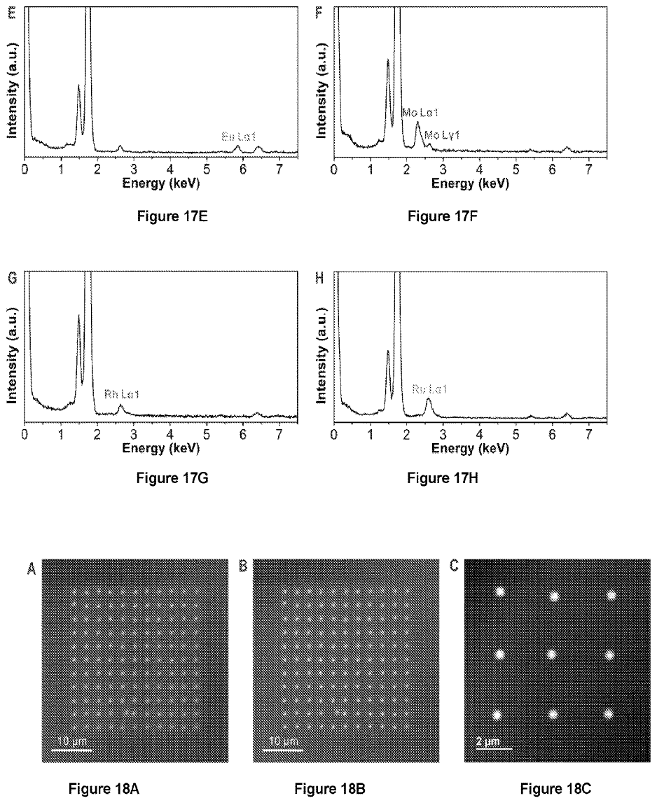

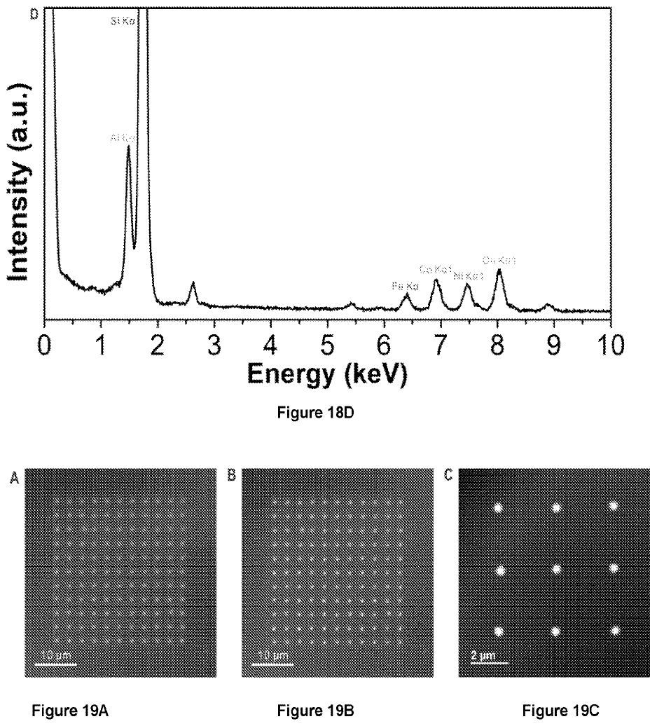

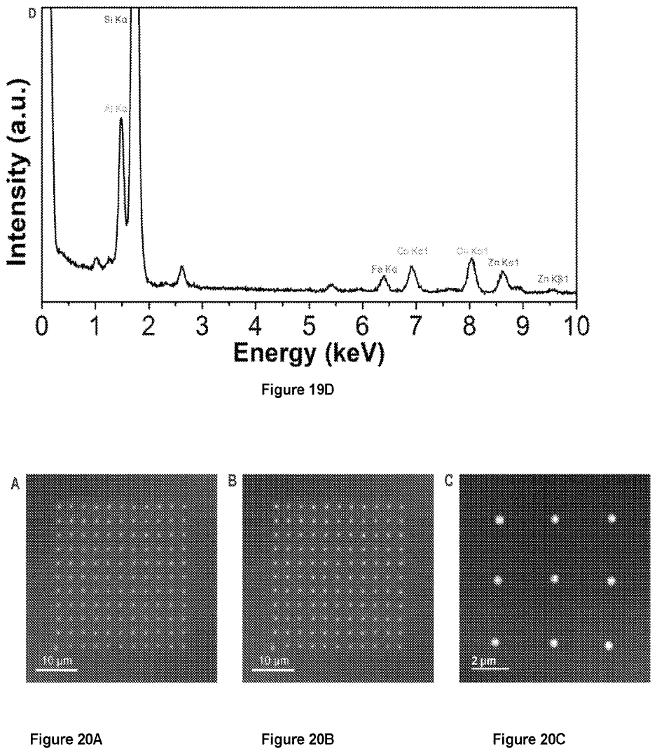

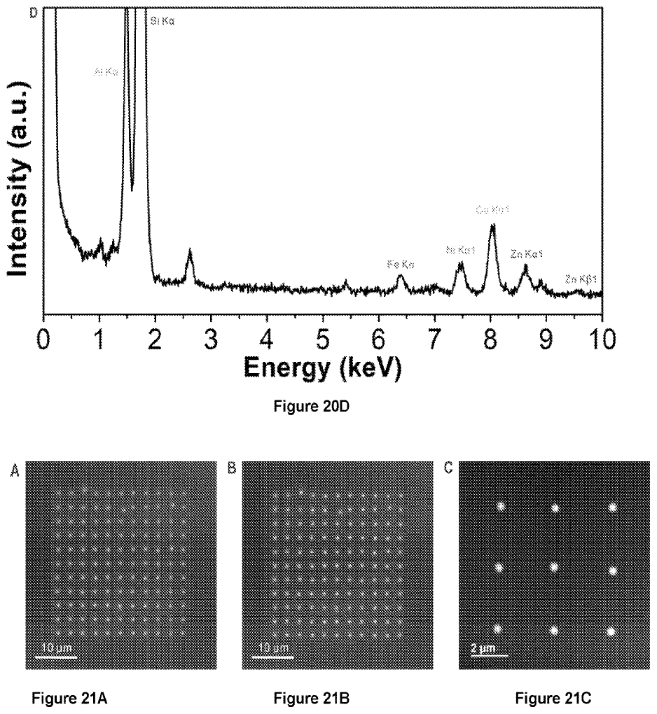

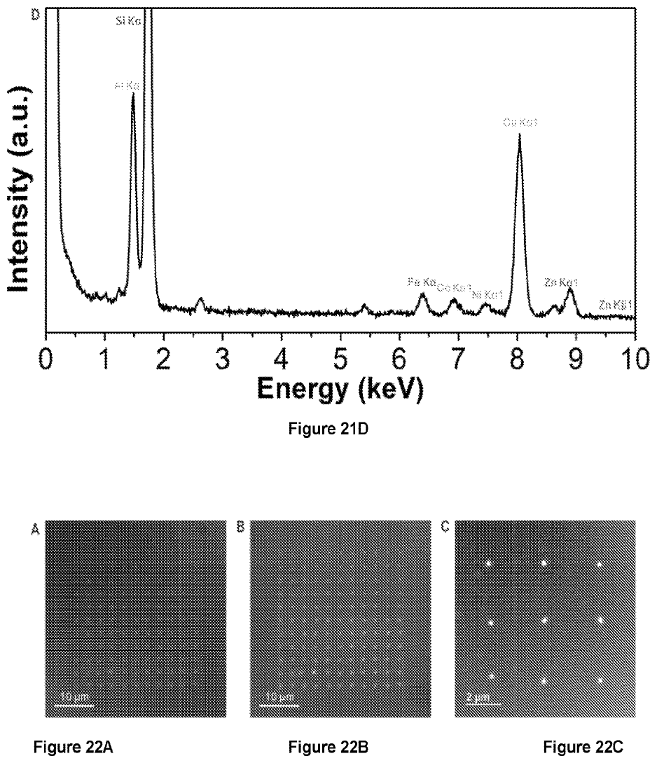

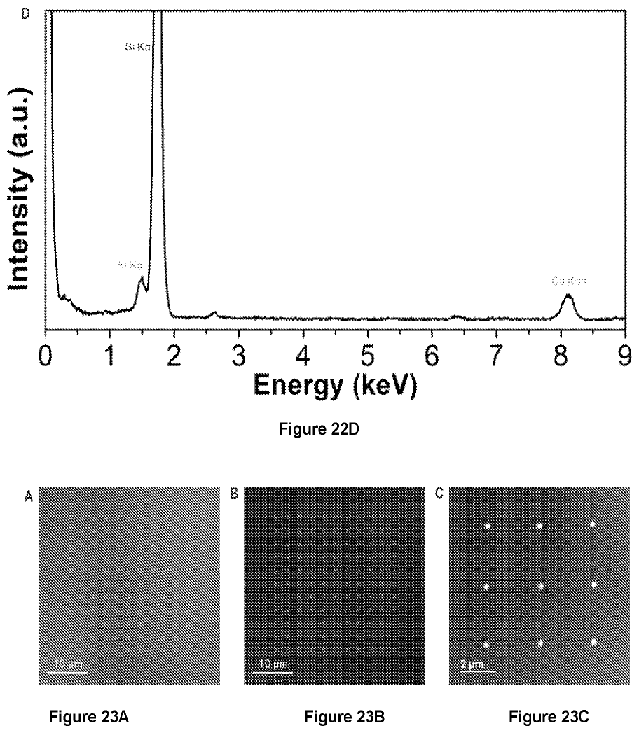

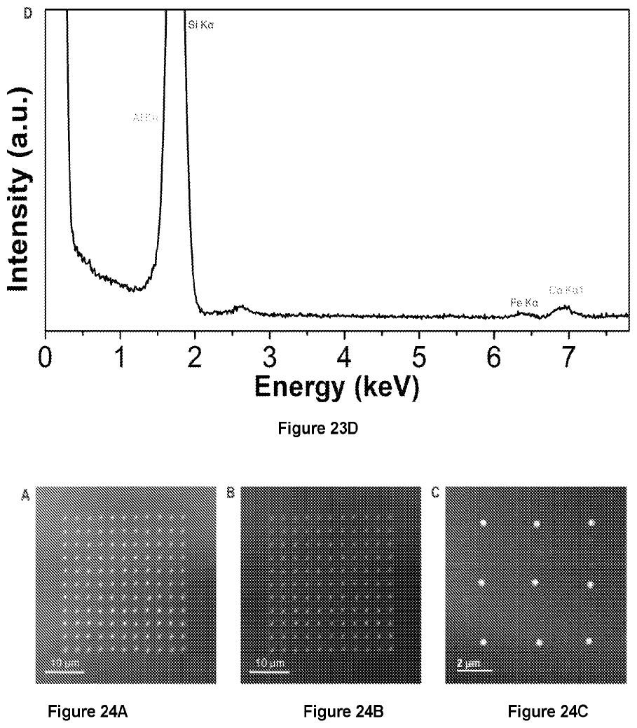

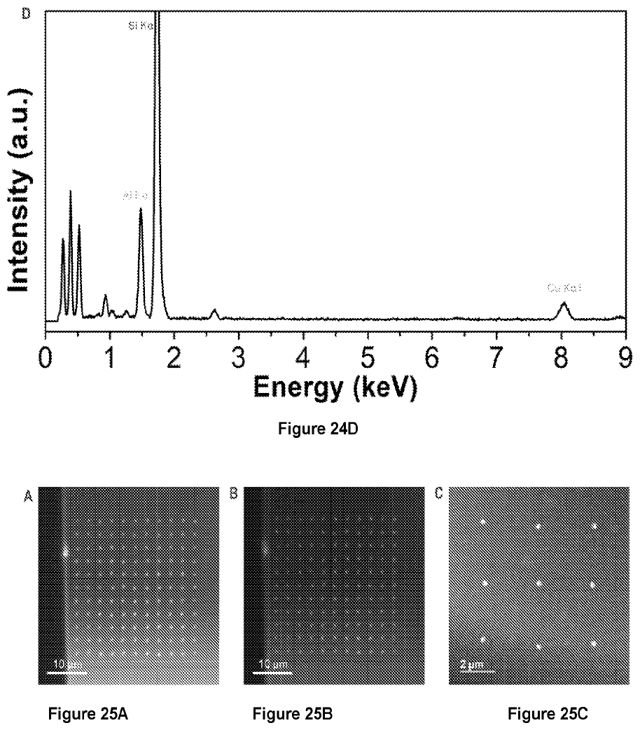

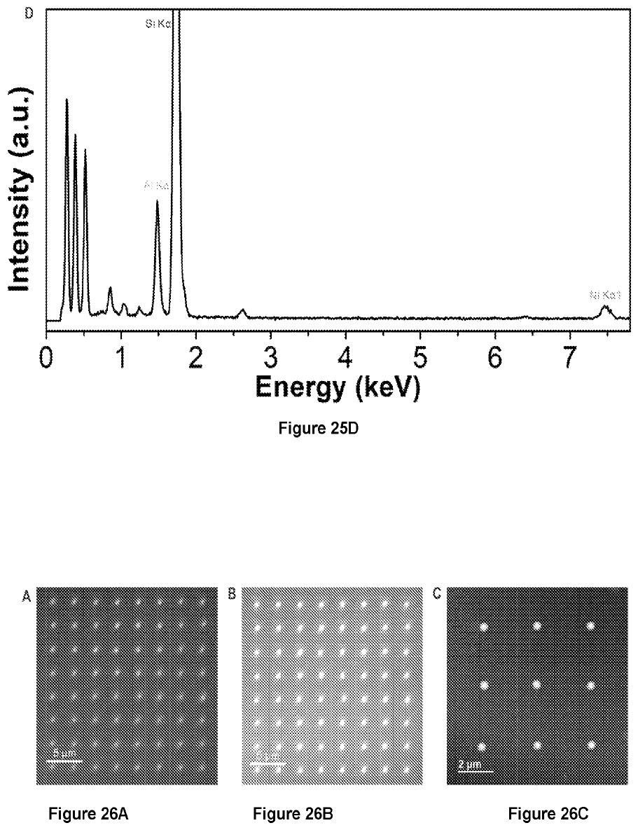

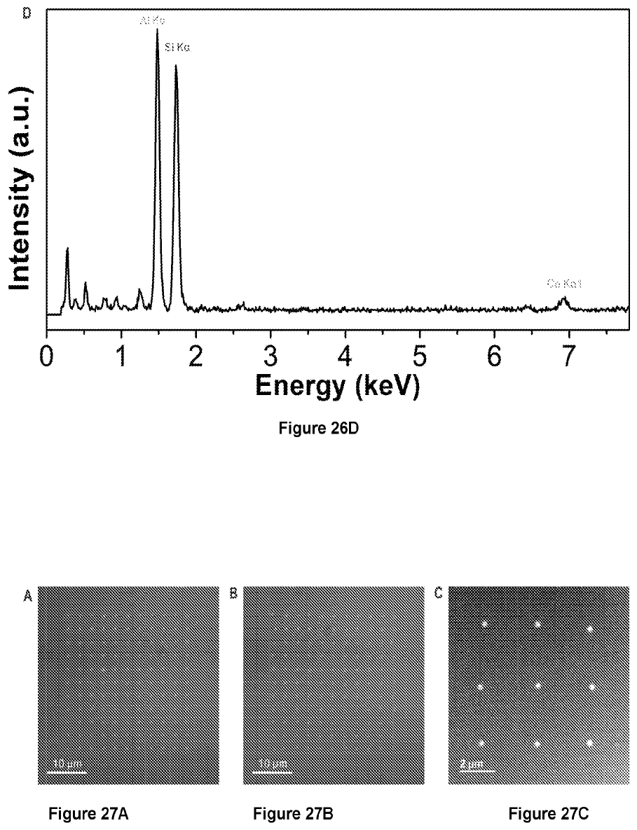

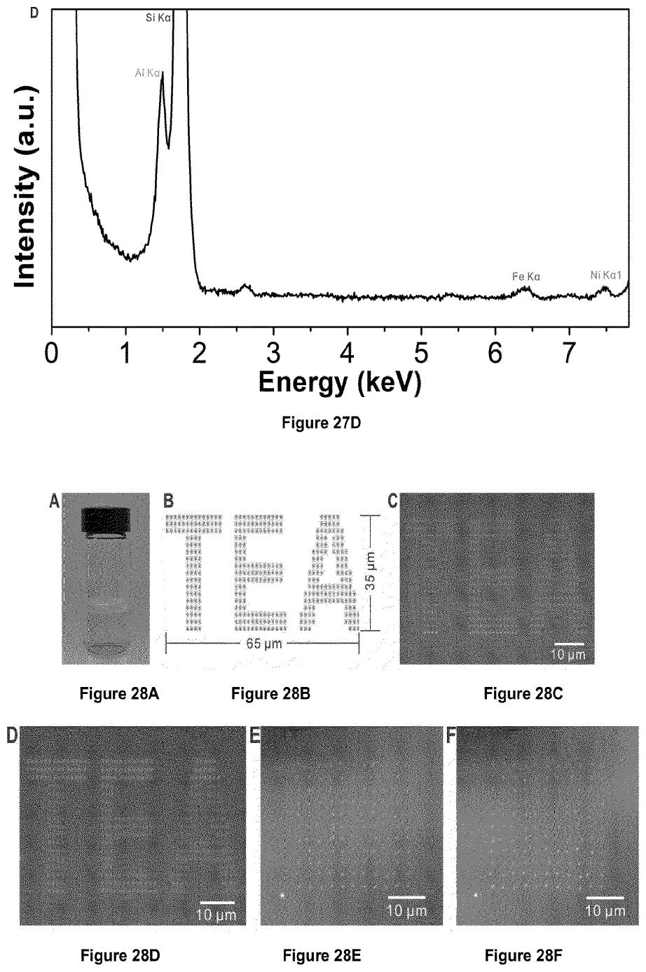

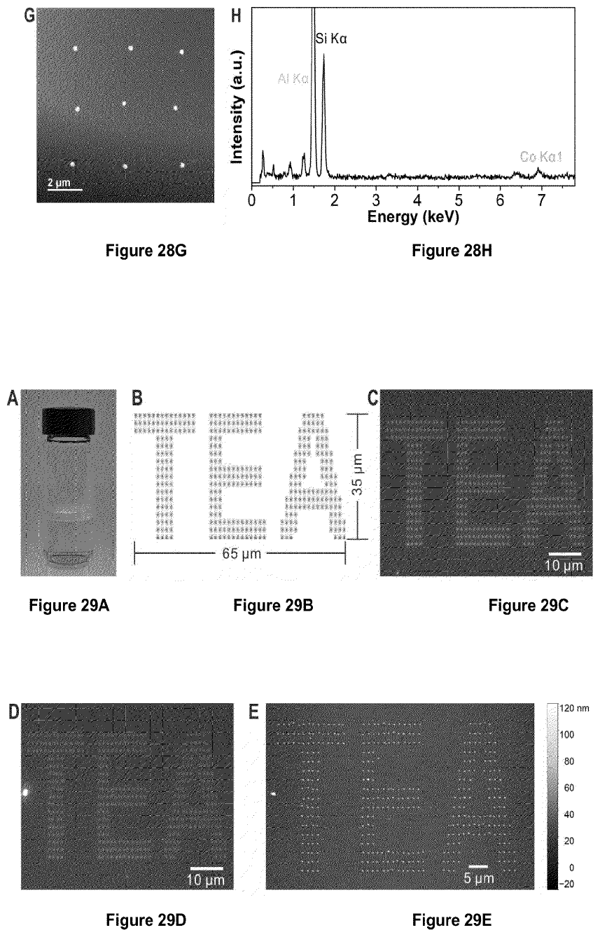

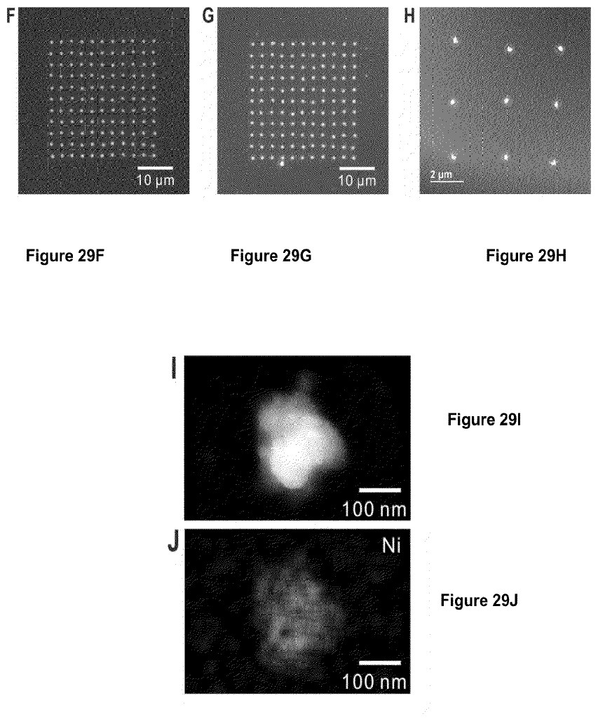

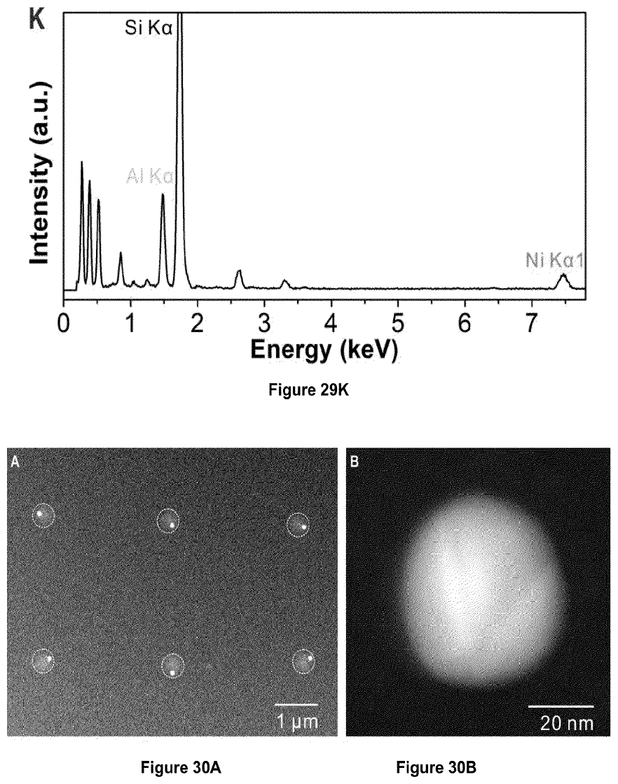

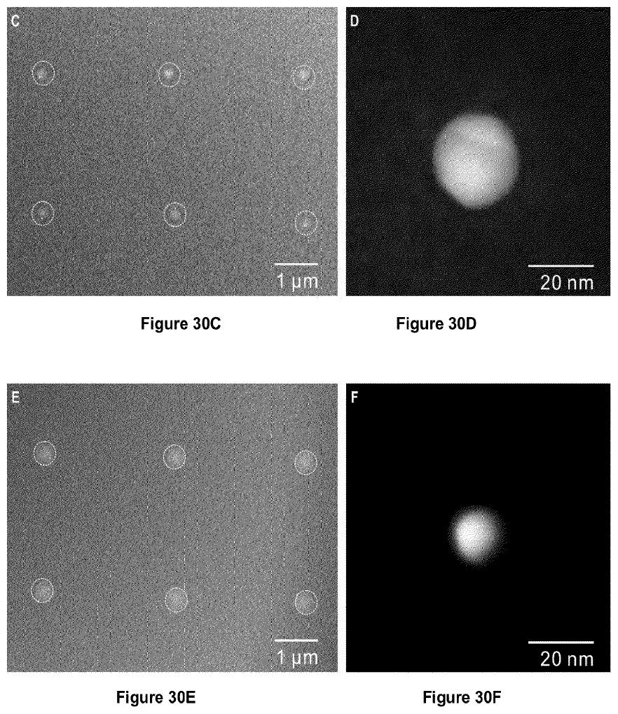

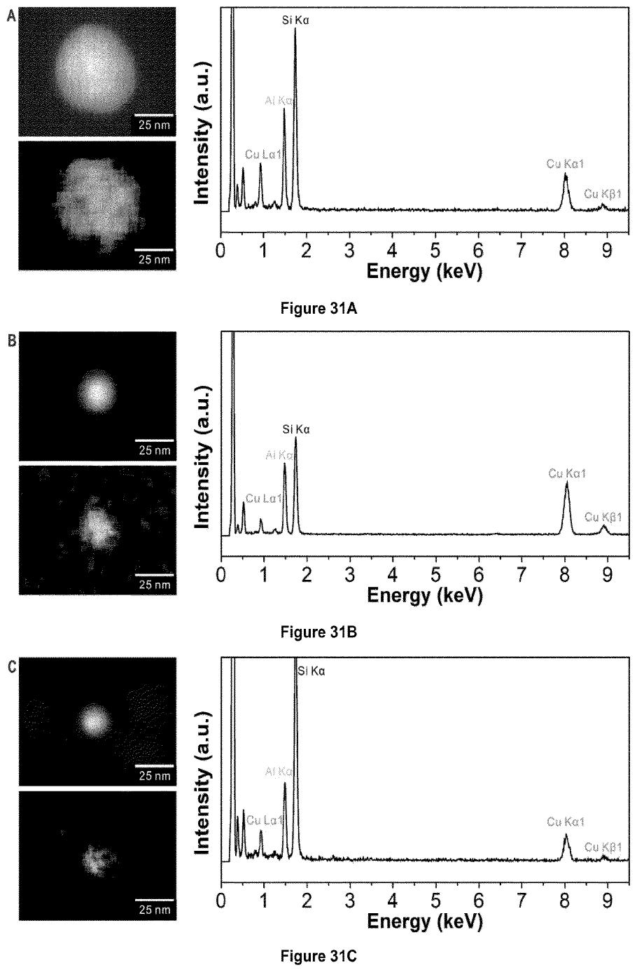

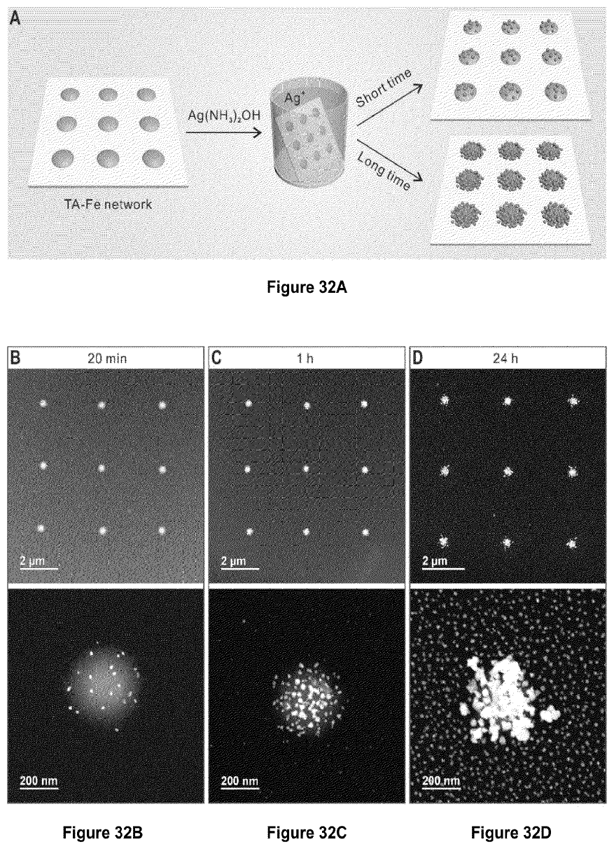

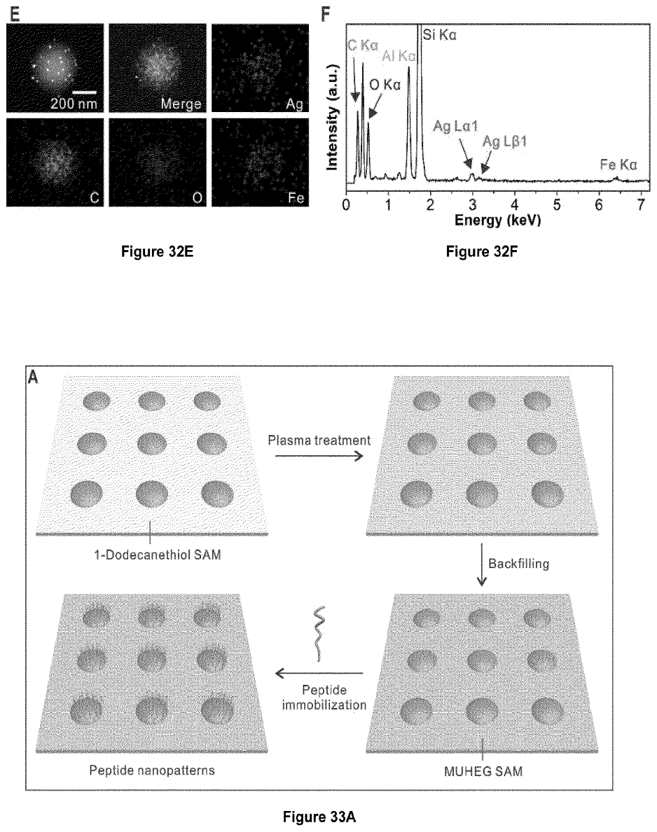

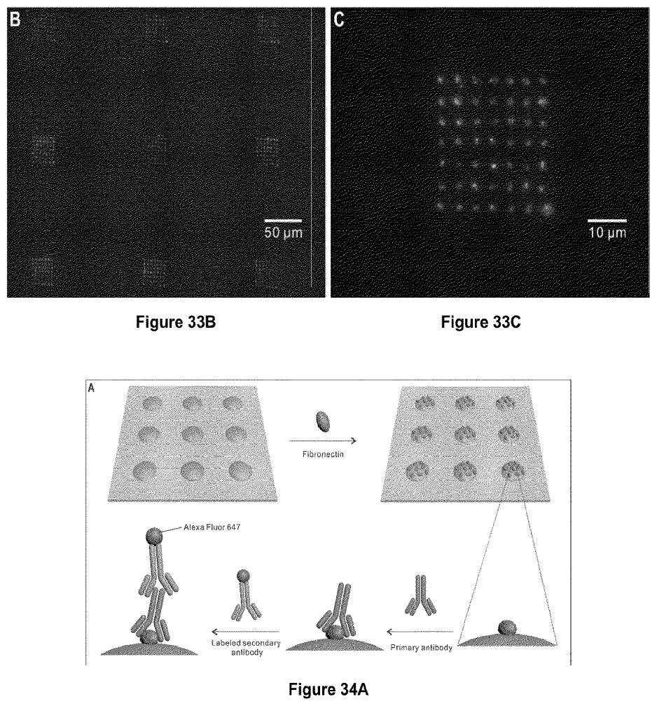

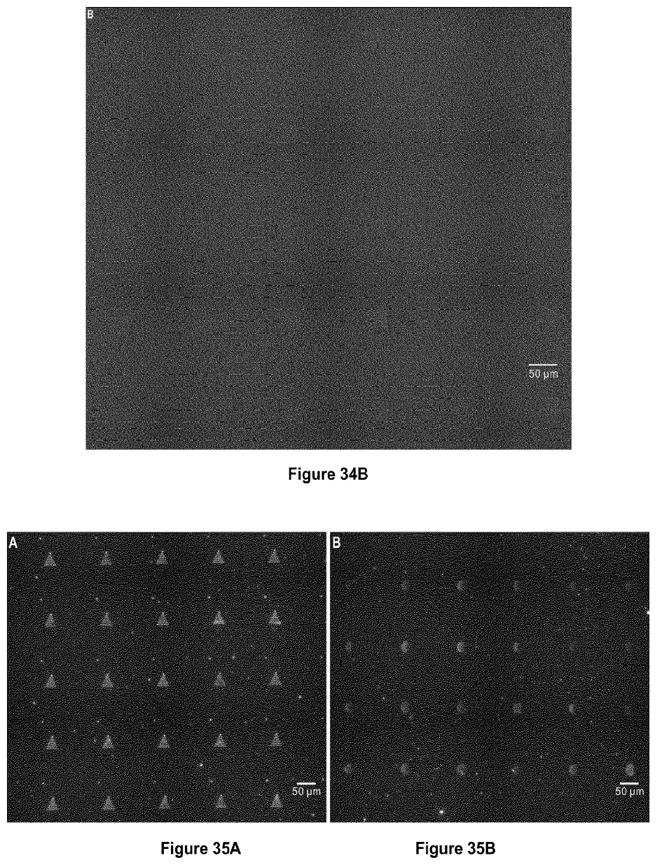

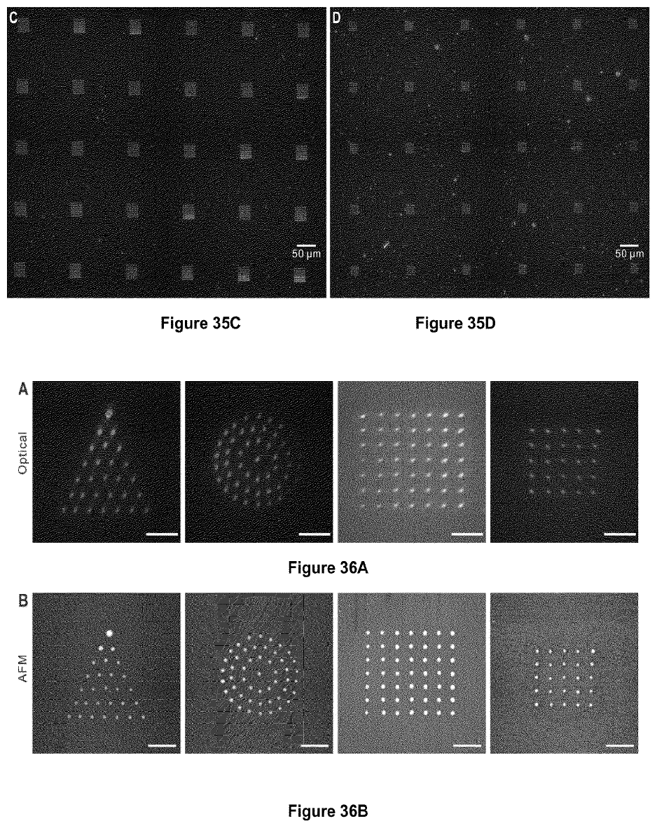

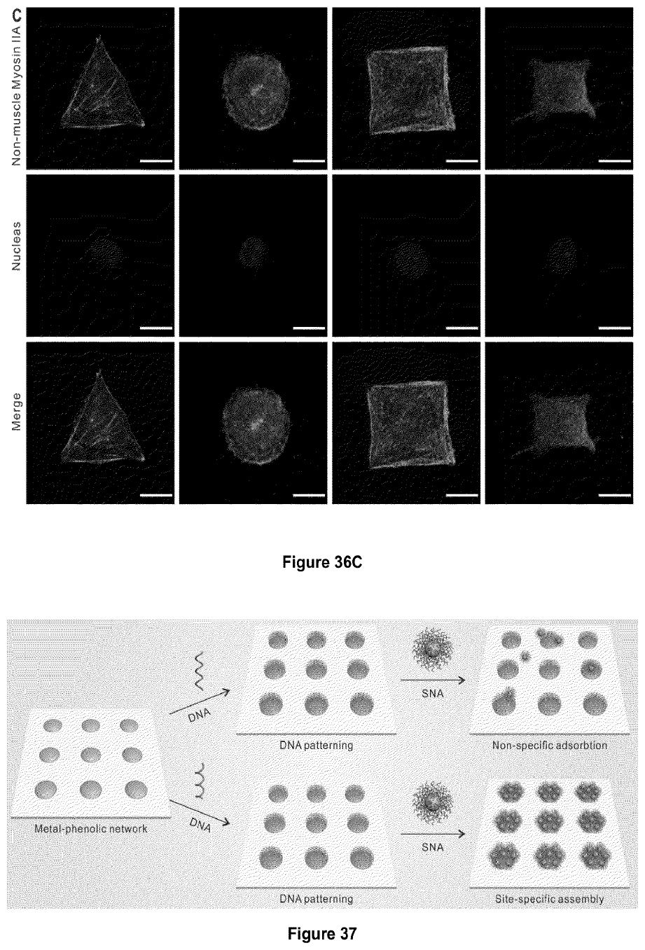

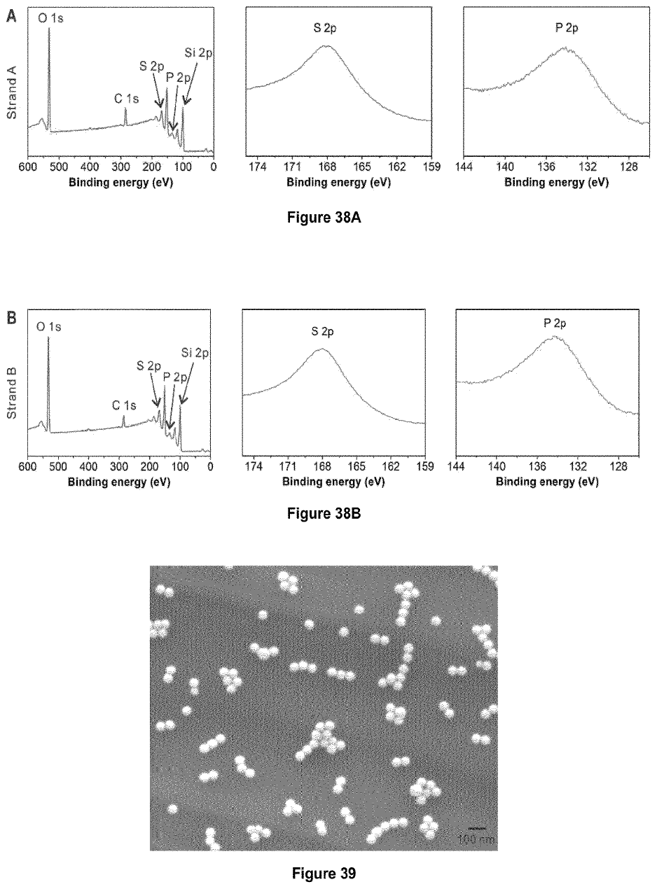

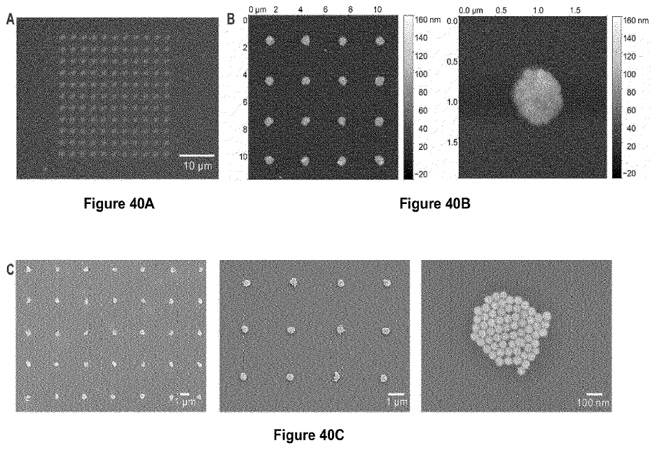

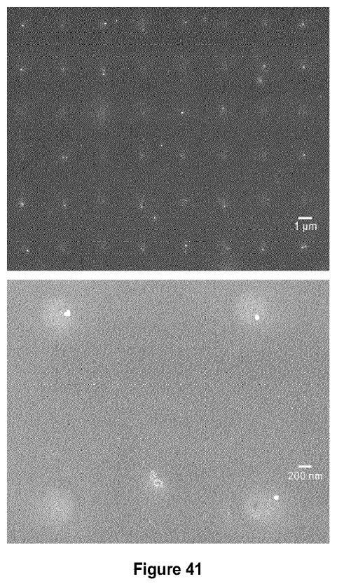

X-ray photoelectron spectroscopy (XPS) was used to confirm that Fe was present in these TA-Fe nanopatterns (FIG. 11). In addition, the Raman spectra for a TA-Fe precursor, a TA-Fe nanopattern and an unpatterned area were compared. The peaks at 1,488 and 1,352 cm⁻¹ indicated the presence of TA and a characteristic shift at 560-610 cm⁻¹ also was observed in the spectra for both patterns (FIG. 1F), attributed to the Fe—O vibration due to galloyl-Fe^{III} interactions. The vibration signal increased after vapor treatment, including that the galloyl-Fell coordinate became stronger through this process. Moreover, a Raman spectroscopy scan of a 4×4 dot array patterned by PPL demonstrated the colocalization of galloyl-Fe coordination bonding and TA (FIG. 12). The TA-Fe inks were also patterned on a transmission electron microscopy (TEM) grid with a silicon nitride support membrane (FIG. 13) and characterized using scanning transmission electron microscopy (STEM) and energy-dispersive X-ray spectroscopy (EDS). The STEM images and the corresponding EDS mapping of a single TA-Fe nanodot (FIG. 1G) again confirmed the distribution and colocalization of C, O, and Fe. Collectively, these results demonstrate that the TA-Fe precursors were successfully written into well-defined nanopatterns using tip-directed chemical synthesis and that ammonia can be used to induce the formation of stable TA-Fe networks.

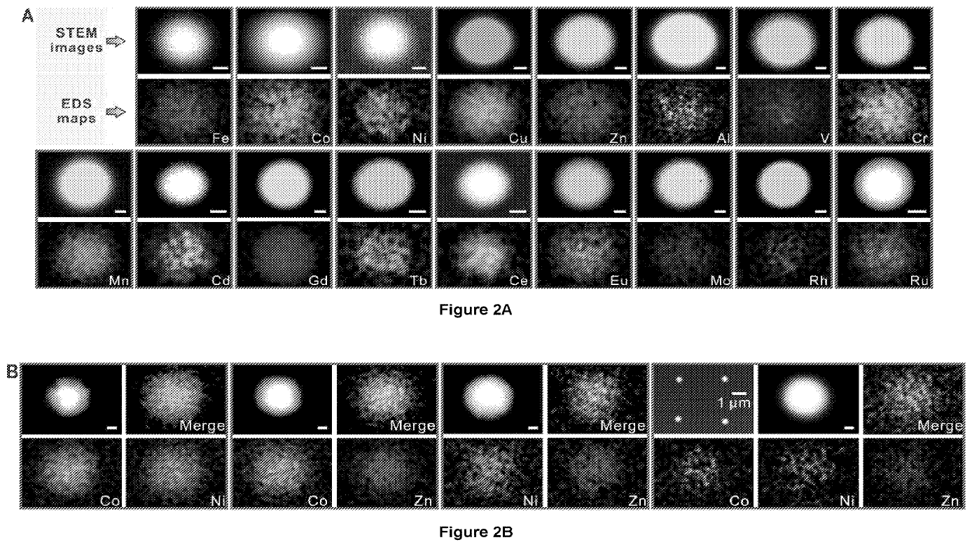

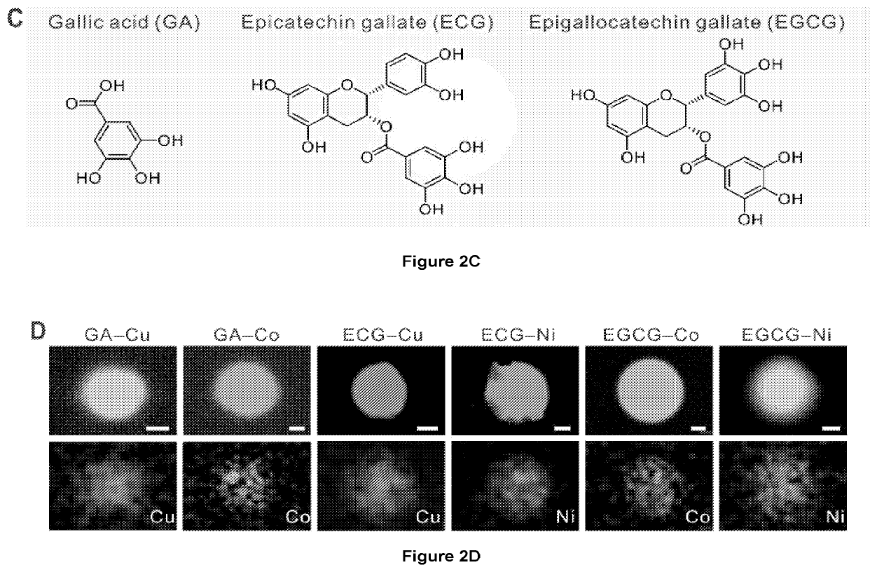

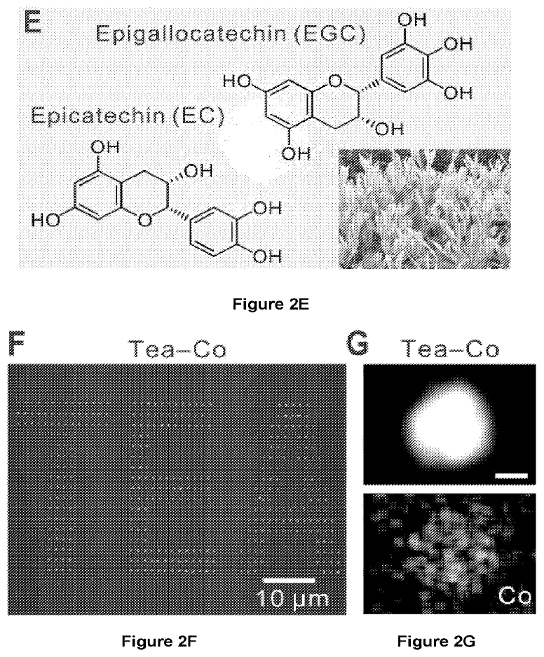

The methods of the disclosure can be generalized to include diverse building block materials. Each metal has unique properties, such as coordination sites and binding constants, allowing the methods of the disclosure to produce MPnPs based on a polyphenol and a variety of metals (FIG. 14) The metal can be one or more of Fe, Co, Ni, Cu, Zn, Al, V, Cr, Mn, Cd, Gd, Tb, Ce, Eu, Mo, Rh, and Ru. Under ammonia vapor, these inks underwent color changes like that seen with the TA-Fe ink (FIG. 14B). The inks were patterned on silicon nitride membranes, and the nanoarrays before and after ammonia treatment were systematically characterized (FIG. 15). After ammonia treatment, all nanopatterns containing the different metal ions in FIG. 2A were stable in water. The STEM images and corresponding EDS data (FIGS. 2A and 16-13) again confirmed the presence and uniform distribution of the metal ions in the formed MPNs. In addition, multiple metal precursors can be mixed in one ink, enabling the construction of MPnPs with multiple metals. The methods of the disclosure have been demonstrated with mixed metal inks having two (Co/Ni, Co/Zn, and Ni/Zn) or three (Co/Ni/Zn) metals (FIGS. 2B and 18-17).

Additionally, polyphenols other than tannic acid can be utilized. For example, the polyphenol can be one or more of tannic acid (TA), gallic acid (GA), epicatechin gallate (ECG), epigallocatechin gallate (EGCG), theaflavin-3′-gallate, and castalagin. Polyphenols can also be used, with different numbers of catechol and galloyl groups. These polyphenols vary in size from 0.6 to 2 nm and have distinct numbers (1-10) of catechol and galloyl groups for coordination. This makes the tested group of polyphenols representative of the larger range of available polyphenols. Various polyphenols were paired with various metal ions for MPnP synthesis (FIGS. 2C-D, and 22-23). It was surprisingly found that, green tea (Yue Xi Cui Lan, Anhui, China), which is a source of polyphenols (FIG. 2E), was capable of being used as a patterning medium when mixed with the appropriate metal salts (FIGS. 2F-G and 28-25). The successful preparation of MPnPs based on different combinations of metal precursors and polyphenols demonstrates the versatility of this approach.

Methods of the disclosure can be used to design functional nanopatterns with tunable properties (e.g., mechanical properties that can be varied based on the strength of coordination between the metal ion and polyphenol). For example, the stability and mechanical properties of nanopatterns can be varied based on the strength of coordination between the metal ion and the polyphenol. For example, due to binding site availability, polyphenols containing galloyl groups are believed to form more stable networks than those with catechol groups. The polymeric, multitopic structure of large polyphenols like TA can provide greater binding affinity to various substrates. These polyphenols also have other different characteristics, such as water solubility. For example, TA has substantially higher solubility than GA, ECG, and EGCG. This can broaden the range of ink concentrations that are suitable for tip-directed patterning.

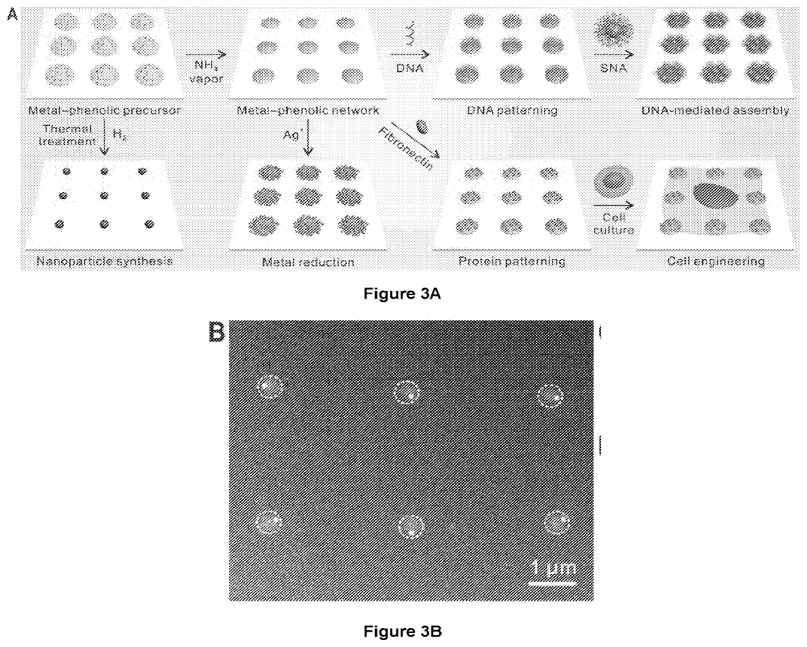

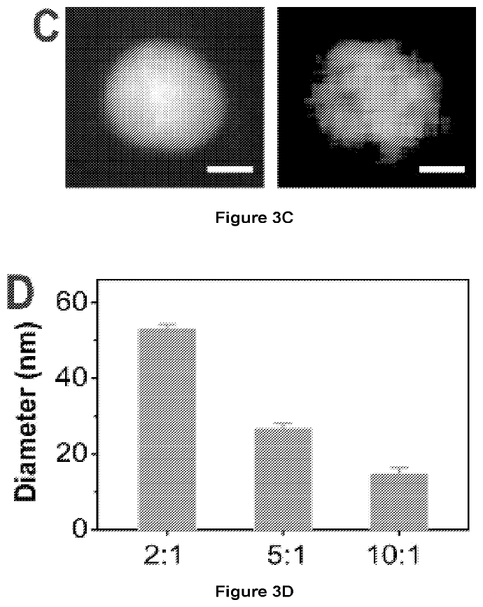

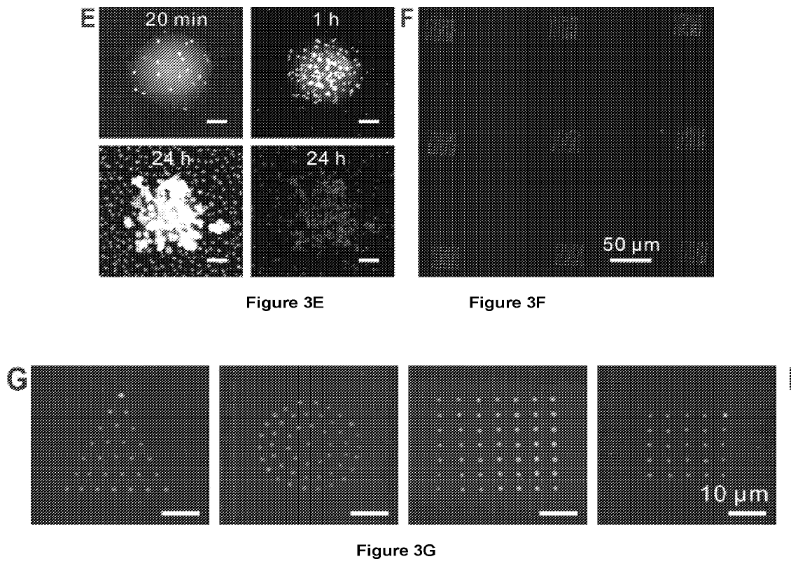

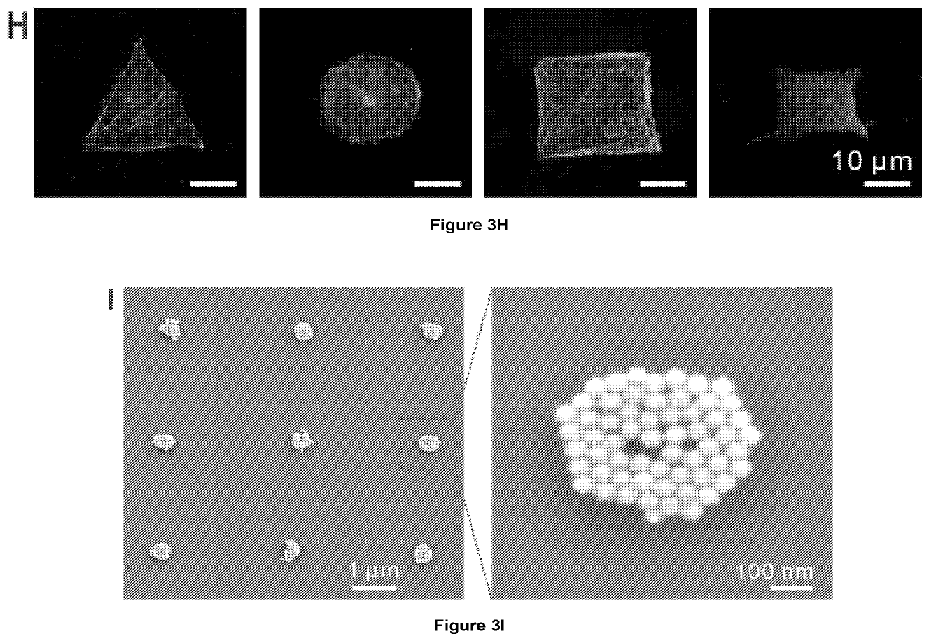

The as-synthesized dynamic MPnPs can be used as a platform for a wide variety of applications (FIG. 3A). For example, metal-phenolic precursor nanopatterns before ammonia treatment were demonstrated as suitable for use as substrate-confined nanoreactors for the synthesis of nanoparticles. A TA-Cu ink with a TA:Cu ratio of 2:1 was patterned on a silicon nitride membrane, followed by programmed annealing at elevated temperatures (180-600° C.) under H₂ flow. Single Cu nanoparticles with an average diameter of ~53 nm were obtained (FIG. 3B-C), due to the relatively weak coordination under acidic conditions the efficient coarsening of Cu nanoparticles occurred. It was observed that the size of Cu nanoparticles can be tuned by adjusting the TA:Cu ratio during patterning (FIGS. 3D and 30-27).

While the methods of forming nanoparticles using polyphenol-based nanoreactors in accordance with the disclosure can result in a similar outcome as the known scanning probe block copolymer lithography (SPBCL) technique; the methods of the disclosure were observed to have several unique advantages. Methods of the disclosure advantageously allow the coarsening kinetics of the nanoparticles to be controlled by varying the pH. This is a result of the ability to tune the coordination strength between the metal ions and polyphenols by varying pH. In addition, polyphenol-based inks are easier to prepare because, unlike the block copolymers used in SPBCL that require sophisticated molecular design and synthesis, the addition of acid, and longer times (up to two days) for metal complexation, phenolic compounds are readily accessible in nature, acidic, soluble, and quickly bind metal ions (so the ink is ready to use immediately after mixing).

Polyphenols are natural antioxidants so they can be used as reducing agents in oxidative reactions, such as the reduction of some metal ions (e.g., Au³⁺, Ag⁺, Pd²⁺) to prepare metal nanostructures. To demonstrate this capability, TA-Fe network nanopatterns were prepared on a TEM grid and their ability to reduce Ag⁺ (FIG. 32A) was examined. The nanopatterns were immersed into silver ammonia [Ag(NH₃)₂OH] solution (20 mM) for different lengths of time (20 min, 1 h, or 24 h). After washing with deionized water and isopropanol, the samples were characterized by STEM and EDS. Discrete Ag nanoparticles were obtained after 20 min (FIGS. 3E and 32), and the nanoparticle density on each pattern increased as a function of immersion time. After treating for 24 h, hierarchical clusters with micro- and nanoscale features were observed. Therefore, MPnPs can provide access to functional surfaces with tunable Ag nanostructures, which may be useful in different fields, such as antibacterial and superhydrophobic surfaces.

Furthermore, because polyphenols can interact with materials through various chemical and physical interactions, MPnPs can be employed as universal anchors for the conjugation of different materials, especially biomolecules (e.g., peptides, proteins, DNA). MPnPs offer the following distinct advantages over traditional methods for biomolecule immobilization that are based on SAMs or polymer brushes: 1) They can be applied to various substrates; 2) The covalent interactions between the polyphenols and the functional groups of biomolecules (e.g., thiols, amino groups) allow for strong immobilization; (3) Due to the pH-responsive nature of MPnPs, the immobilized species may be detached from the substrate under acidic conditions, if desired. To demonstrate this capability, a cysteine-terminated and tetramethylrhodamine (TAMRA)-labeled peptide was used to functionalize TA-Fe network nanopatterns on Au-coated glass. The thiol group of cysteine can react with the oxidized quinones of the TA via Michael addition. To avoid nonspecific adsorption, the background was cleaned using oxygen plasma and backfilled with (11-mercaptoundecyl) hexa (ethylene glycol) (MUHEG) (FIG. 33A). Subsequently, the patterned TA-Fe networks were incubated in the peptide solution (0.1 mM) for 2 h, and then washed with water thoroughly and dried under N₂. Immunofluorescent micrographs clearly showed the site-specific attachment of the TAMRA-labeled peptides (FIG. 33B-C).

In addition, oxidized quinones may also react with amino groups via Michael addition and Schiff base reaction. Therefore, MPnPs can be employed as a general platform for the covalent immobilization of proteins; most proteins have large numbers of amino groups on their surfaces. As a proof-of-concept, fibronectin, a large glycoprotein, was introduced in the extracellular matrix onto the TA-Fe nanopatterns. The fibronectin-functionalized substrate was sequentially treated with human anti-fibronectin primary antibody and Alexa Fluor 488-conjugated goat anti-rabbit secondary antibody (FIG. 34A), and immunofluorescence images revealed that fibronectin was successfully immobilized in a site-selective fashion and its bioactivity was not affected (FIGS. 3F and 34B).

Significantly, these protein-functionalized bioactive nanopatterns can be useful for both fundamental and applied biological studies. As an example, four types of TA-Fe network patterns were prepared with controlled shapes on Au-coated glass by PPL: a triangle, a circle, and two rectangles of different sizes (FIGS. 3G and 35). After incubating with fibronectin, these functionalized surfaces were used for the culture of NIH 3T3 fibroblast cells. Cell growth was controlled on the corresponding patterns, and cells with different sizes, shapes, morphologies, and contractilities, which can be attributed to the presence of fibronectins, were observed (FIGS. 3H and 36). MPnPs can be a powerful tool for cell manipulation and can further be used to investigate cell behaviors, such as cell differentiation and endocytosis.

Due to its highly specific base-pairing interactions, DNA has been extensively exploited for the programmable assembly of nanomaterials. To further explore the versatility of this platform, TA-Fe network nanopatterns were used in the context of DNA functionalization, to permit the assembly of functional objects on patterned substrates (FIG. 37). To this end, two thiol-terminated anchor DNA strands: A and B were designed and synthesized (Table 1). Two TA-Fe network nanopatterns fabricated by DPN on Si were then incubated with 5 nmol solutions of dithiothreitol (DTT)-cleaved anchor DNA strands A and B, respectively. The XPS spectra show the characteristic signals of P and S, indicating the successful attachment of anchor DNA strands (FIG. 38). To demonstrate DNA-mediated assembly, gold nanoparticles were synthesized and then functionalized with anchor DNA strand A to form spherical nucleic acids (SNAs), a type of “programmable atom equivalent” (average core diameter ~50 nm) (FIG. 39). Subsequently, SNAs and DNA-functionalized nanopatterns were hybridized with linker strands (SNAs: L_{A}; Substrates: L_{A} or L_{B}; Table 1), where L_{A} specifically binds with anchor A, and L_{B} with anchor B. After linker hybridization, the substrates were immersed in solutions of SNAs. Dense and highly site-specific assembly of SNAs (L_{A}) was observed when a complementary strand was used for the nanopatterns (L_{B}), and uniform, single-layer, two-dimensional clusters of gold nanoparticles were formed that may have interesting optical properties (FIGS. 3I and 40). In contrast, when non-complementary DNA strands were used for SNAs (L_{A}) and the nanopatterns (L_{A}), only a few discrete particles were observed on some of the nanopatterns (FIG. 41), attributed to non-canonical adsorption based on the hydrogen bonding between the phosphate backbone of DNA and the catechol and galloyl groups of TA. This result not only demonstrates that DNA strands were successfully immobilized, but also points toward the potential of MPnPs as a general platform for DNA nanopatterning, allowing for the programmable assembly of various nanoobjects on different substrates.

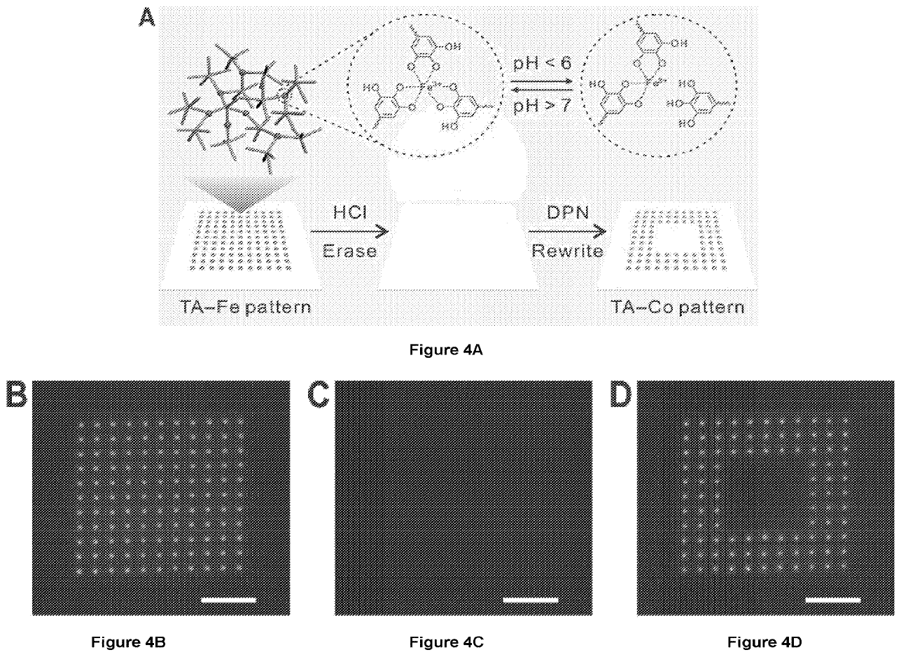

One significant feature of metal-phenolic complexes is their pH-responsiveness. The exposure of macroscale TA and TA-Fe droplet arrays to ammonia vapor triggered color changes for both inks in less than 5 min. This process is reversible after treatment with HCl vapor, highlighting the dynamic nature of the coordination interactions. MPN nanopatterns formed to erase and rewrite on surfaces (FIG. 4A). An 11×11 TA-Fe network dot array on Si substrate was prepared, which was stable in water after ammonia treatment (FIG. 4B). However, when the dot array was immersed in HCl solution (pH ~3) for 15 min, the patterned molecular networks completely disassembled (FIG. 4C), due to the transition of the coordination state from the tris- to bis-complex (FIG. 4A). A hollow square TA-Co nanodot array was rewritten on the same location using DPN (FIG. 4D), showing that different MPnPs of distinct shapes can be facilely rewritten. Therefore, the combination of tip-directed techniques and metal-phenolic coatings can be regarded as a highly reprogrammable tool for surface nanopatterning and functionalization.

### EXAMPLES

### Materials

Tannic acid (TA, 98%), gallic acid (GA, ≥98%), epicatechin gallate (ECG, ≥98%), epigallocatechin gallate (EGCG, ≥95%), iron(III) chloride hexahydrate (FeCl₃·6H₂O, 98%), cobalt(II) nitrate hexahydrate [Co(NO₃)₂·6H₂O, 98%], nickel(II) chloride hexahydrate (NiCl₂·6H₂O, 99.9%), copper(II) nitrate hydrate [Cu(NO₃)₂·xH₂O, 99.999%], zinc nitrate hydrate [Zn(NO₃)₂·XH₂O, 99.999%], manganese(II) chloride (MnCl₂, 99%), chromium(III) chloride hexahydrate (CrCl₃·6H₂O, 98%), vanadium(III) chloride (VCl₃, 99%), aluminum nitrate nonahydrate [Al(NO₃)₃·9H₂O, 99.997%], zirconium (IV) chloride (ZrCl₄, 99.99%), molybdenum(II) acetate dimer [Mo₂(OCOCH₃)₄, 98%], ruthenium(III) chloride (RuCl₃, Ru content 50%), rhodium(III) chloride (RhCl₃, 98%), cadmium chloride (CdCl₂, 99.99%), cerium(III) nitrate hexahydrate [Ce(NO₃)₃·6H₂O, 99.99%], europium(III) chloride (EuCl₃·6H₂O, 99.99%), gadolinium(III) chloride hexahydrate (GdCl₃·6H₂O, 99.999%), terbium(III) chloride hexahydrate (TbCl₃·6H₂O, 99.999%), silver nitrate (AgNO₃, ≥99%), gold(III) chloride trihydrate (HAuCl₄·3H₂O, ≥99.9%), hexamethyldisilazane (99%), 11-mercaptoundecyl) hexa (ethylene glycol) (MUHEG, 99%), cetyltrimethylammonium bromide (CTAB, 99%), sodium borohydride (NaBH₄, 99.99%), and 16 mercaptohexadecanoic acid (MHA, 90%) were purchased from Millipore Sigma. Ammonium hydroxide (28~30% as NH₃) was bought from Mallinckrodt Chemicals. Green tea (Yue Xi Cui Lan,) was obtained from Yuexi County, Anhui Province, China. Dulbecco's modified eagle medium (DMEM) and 1% penicillin-streptomycin was purchased from Fisher Scientific and Gibco, respectively. NIH/3T3 embryonic fibroblast cells were obtained from ATCC. 10% fetal bovine serum was obtained from ATLANTA biologicals. Human fibronectin was purchased from EMD Millipore. Prolong gold antifade mountant with 4′,6-diamidino-2-phenylindole (DAPI) was purchased from ThermoFisher. Anti-human fibronectin antibody produced in rabbit was purchased from Abcam. Alexa Fluor 488 Goat anti-rabbit secondary antibody and 16% formaldehyde solution (w/v) were purchased from Fisher Scientific. BD cytofix/cytoderm buffer was purchased from BD Bioscience. One-dimensional pen arrays (type M) for DPN experiments were purchased from Advanced Creative Solutions Technology LLC. Silicon nitride membranes for TEM (15 nm with 9 each 0.1×0.1 mm windows) were purchased from Ted Pella Inc. Silicon wafers were purchased from Nova Electronic Materials. Deionized water was produced from a Millipore Milli-Q purification system (resistivity at 25° C.=18.2 MΩ·cm). PPL pen array with a pen-to-pen distance of 150 μm was purchased from TERA-print.

### Characterization

### UV-Vis Spectroscopy

UV-vis spectroscopy was carried out in the range of 200 to 800 nm at RT on an Agilent Cary 60 UV-Vis spectrophotometer using a high precision quartz cuvette (Hellma Analytics, volume 160 μL, light path 10 mm, center height 15 mm). The scanning rate was set as 24000 nm/min and the data interval of 5 nm.

### Optical Images and Videos

Optical microscopy was conducted using a Carl Zeiss Axio Imager.M2m microscope equipped with an X-Cite® 120Q excitation light source and an Axiocam 305 color camera. Optical photographs and videos were taken by a Huawei Mate 20 smartphone.

### Scanning Electron Microscopy (SEM)

SEM was performed on a JEOL JSM-7900FLV at an acceleration voltage of 5 kV.

### Scanning Transmission Electron Microscopy (STEM)

A Hitachi HD-2300 STEM was used to image the nanopatterns and metal nanostructures synthesized on TEM membranes at an acceleration voltage of 200 kV. The dark-field images were taken with an annular dark-field (ADF) detector. The composition of nanopatterns or nanoparticles was studied using the dual energy-dispersive X-ray spectroscopy (EDS) detectors on the HD-2300 STEM. Each EDS map is built based on 30~300 frames with frame time of 10 s. Thermo Scientific Pathfinder 2.8 X-ray microanalysis software was used for background subtraction in the EDS maps.

### Atomic Force Microscopy (AFM)

The measurements were performed on a Bruker Dimension FastScan® Atomic Force Microscope. Tapping mode in air standard was selected while the TESPA cantilever probe was in place all the time. The scan parameters were adjusted after the probe approached the sample. The amplitude setpoint was reduced by 15% once the surface was approached. The scan rate was kept at 0.99 Hz and the samples/line at 2048 for all the AFM scans. The scan size ranged from 1 μm to 70 μm. Images were processed in Gwyddion 2.48.

### X-Ray Photoelectron Spectroscopy (XPS)

Thermo Fisher Escalab 250Xi at 10⁻⁸ mbar equipped with an Al-Kα X-ray source (1486.6 eV, with monochromator) was used for the collection of XPS spectra. The spot size was 500 μm with a charge compensation applied. A survey spectrum that covered from 0 to 1200 binding energy (eV) was collected and higher resolution spectra were collected in the carbon C 1s, oxygen O 1s, and iron Fe 2p regions. The number of scans for each element was 20 with a dwell time of 50 ms. High resolution scans were collected with 1 eV energy step size. All spectra were shifted by calibrating the obtained C 1s peaks to 284.6 eV.

### Raman Spectroscopy and Mapping

A Horiba LabRam Confocal Raman was employed for data collection. The patterned substrate was taped onto a cover slip and fixated on the holder. 532 nm laser was used, and the grating was selected at 1800 gr mm⁻¹. The focus light and the video camera were turned on to identify the pattern area on the substrate. A 10× lens was used for focus and then gradually switched to 50× then 100× lens for analysis. ND filter was set to 25% and the camera to standard mode. HJY detector and Marzhauser stage xy mode were selected. Representative spots on the TA-Fe nanopatterns and in the background area were selected, and measurements were taken in the range from 400 cm⁻¹ to 1600 cm⁻¹. To show the colocalization of galloyl-Fe coordination and TA, a map containing 21×21 spots was generated to obtain an overlapping image based on peaks at 580 cm⁻¹ and 1488 cm⁻¹.

### Matrix-Assisted Laser Desorption Ionization-Time of Flight (MALDI-ToF) Mass Spectrometry

MALDI-TOF mass spectra were collected on a Bruker rapiflex tissue typer. Saturated solution of 2′,6′-dihydroxyacetophenone (DHAP) in methanol was used as the matrix solution.

### Preparation of Polyphenol-Based Inks

TA-based inks were prepared by dissolving TA, glycerol, and various metal-ion precursors in deionized water in predetermined molar ratios. In a typical example for the preparation of TA-Fe ink, 170 mg TA and 27 mg of FeCl₃·6H₂O were dissolved in 30 ml deionized water. 340 μL of glycerol (1%, v/v) was then added to increase the viscosity to facilitate the following tip-directed patterning. By further adding deionized water, the concentration of TA was tuned to 5 mg mL⁻¹ and the molar ratio of TA to Fe was 1:1. The ink solution was stirred for at least 2 h at room temperature before use.

For TA-based inks containing other metal ions, the concentration of TA was kept at 5 mg mL⁻¹ and the molar ratio of TA to metal ion was set as 1:1. For the preparation of TA-Rh ink, the RhCl₃ powder was dispersed in dilute HCl (pH ~1) and then dissolved using sonication and heat. For the preparation of TA-Mo and TA-Ru inks, sonication was required for dissolving Mo₂(OCOCH₃)₄ and RuCl₃ precursors. To prepare inks with two or three different metal ions, equal volumes of the above inks containing corresponding metal precursors were mixed. For the synthesis of Cu single nanoparticles, the concentration of TA was 5 mg mL⁻¹, and the molar ratio of TA to Cu was varied from 2:1 to 10:1.

Other inks based on different polyphenols (GA, ECG, and EGCG) were prepared according to similar protocols. It was found that 5 mg/mL was an appropriate concentration for most polyphenols. However, ECG had limited solubility of <1 mg/mL in water. Therefore, 0.5 mg/mL was used for ECG-based inks. Unless otherwise noted, the concentration of polyphenol was 5 mg mL⁻¹ and the molar ratio of polyphenol to metal ion was 1:1. For GA-based inks, the molar ratio of GA to metal ion was 10:1. For the EGCG-Ni ink, the molar ratio of EGCG to Ni was 5:1. These molar ratios were determined after considering the solubility of each metal salt and the molecular weight of each polyphenol.

For the preparation of green tea-based ink, 500 mg green tea leaves were added into 100 mL of boiled water. After 20 minutes, the obtained tea solution was sequentially passed through two PTFE syringe filters with pore sizes of 0.7 μm and 0.2 μm. Glycerol (1%, v/v) was then added to increase the viscosity of the solution. Green tea-Co and green tea-Ni inks were obtained by adding 8.2 mg Co(NO₃)₂·6H₂O and 7.2 mg NiCl₂·6H₂O into 10 ml of the obtained solution, respectively. The inks were stirred for at least 2 h at room temperature prior to use.

### Dip-Pen Nanolithography (DPN) Patterning Process

Both silicon wafers and TEM membranes (with silicon nitride support films) were treated for hydrophobicity before DPN patterning.¹ They were placed in a desiccator that contained a small vial of hexamethyldisilazane (HMDS) and hexane in 1:1 ratio (v/v) overnight. For DPN experiments, a one-dimensional pen array was dip-coated with a polyphenol-based ink. After drying under ambient conditions, the pen array was mounted onto a modified atomic force microscope (AFM) instrument (Park Systems XE-150) in a chamber. The temperature was set as 20° C. and the relative humidity was 80~85%. The array was leveled in parallel with the substrate before patterning. Predesigned nanopatterns were then made by bringing the pen array in contact with the substrate to deposit the ink.

### Polymer Pen Lithography (PPL) Patterning

A pen array with a pen-to-pen distance of 150 μm was treated with oxygen plasma for 1 min at 30 W before spray coating. 100 μL ink solution was sprayed onto the pen array with a spray gun before loading it into the PPL system. A 2 cm×2 cm HMDS treated silicon substrate or a 2 cm×2 cm 1-dodecanethiol treated, Au-coated ITO glass was mounted on the PPL system (TERA Fab M series, TERA print LLC) using a carbon taped magnet. The voltage and contact current threshold of the electrical feedback were set to 10 V and 0.01 mA, and the chamber humidity was held at 80~85% to achieve optimal patterning. The long travel z motion was used to gradually move the pen array closer to the substrate. After the auto-alignment was completed, force feedback was used to obtain an optimal local force maximum (~1800 mN). The pattern design was enabled by the PPL software, and the patterning process was carried out after the touch position was saved.

### Ammonia Vapor Treatment

For the formation of metal-phenolic networks, the substrates or TEM membranes after DPN or PPL patterning were placed in a petri dish (Quad-Plate). At least 1 mL of ammonium hydroxide was then added to a neighboring area, creating ammonia vapor in the petri dish. The nanopatterns were treated for at least 30 minutes to allow the formation of stable networks.

### Thermal Treatment of TA-Cu Nanopatterns

For the synthesis of Cu nanoparticles on surfaces, the TA-Cu nanopatterns on TEM membranes with different TA:Cu molar ratios were transferred into a tube furnace for annealing. This is a similar process to the on-surface synthesis of nanoparticles by scanning probe block copolymer lithography (SPBCL). The treatment was programmed as follows: under H₂ flow, ramp to 180° C. within 1 h, hold at 180° C. for 48 h, ramp to 600° C. in 2 h, hold at 600° C. for 22 h, and finally cool down to room temperature in 4 h.

### Preparation of Ag Nanostructures on TA-Fe Patterns

Silver ammonia [Ag(NH₃)₂OH] solution was prepared by dissolving 34 mg of AgNO₃ in 1 mL of deionized water, followed by addition of ammonium hydroxide to the solution until the brown precipitation was completed dissolved. The concentration of the final solution was tuned to 20 mM by adding deionized water. TA-Fe nanopatterns on TEM membranes were immersed in the above solution for different determined periods (20 min, 1 h, 24 h). The samples were washed with deionized water and isopropanol before characterization.

### Immobilization of Peptides and Proteins

The ITO glasses were cut into 2 cm×2 cm squares and sonicated for 30 min, followed by ethanol rinsing and drying with N₂. The depositions of 5 nm Cr and 35 nm of Au were enabled by an electron beam evaporator (Lesker) after the vacuum reached 2×10⁻⁷ mTorr. The Au-coated ITO glasses were then placed in a petri dish filled with 10 mM of 1-dodecanethiol dissolved in ethanol for 24 h on a shaker. The pen arrays were spray inked with TA-Fe solutions, and the PPL patterning process was carried out following the procedure described in PPL patterning. The pattern substrates were treated with oxygen plasma for 30 s to remove the bound 1-dodecanethiol in the background followed by an overnight ammonium vapor treatment. The pattern substrates were immersed in solutions made of 1 mM (11-mercaptoundecyl) hexa (ethylene glycol) (MUHEG) in ethanol for 30 min to avoid any non-specific binding of biomolecules. The pattern substrates were washed three times with 1×PBS prior to biomolecule functionalization. For peptide immobilization, the tetramethylrhodamine (TAMRA) labeled peptide [CKVPRNQDWL-K (TAMRA) (SEQ ID No. 1): LCMS 90~95%, MW: 1798 g mol⁻¹] was synthesized and purified by the Peptide Synthesis Core at Northwestern University. The pattern substrates were soaked in solutions containing 0.1 mM of CKVPRNQDWL-K (TAMRA) (SEQ ID No. 1) dissolved in 10% DMSO in water and incubated for 2 h on a shaker. The substrates were washed with water and dried under N₂ before imaging.

For fibronectin immobilization, the pattern substrates were placed in 6 well plates filled with 25 μg mL⁻¹ fibronectin in 1×PBS and incubated on a shaker overnight at 80 rpm at 4° C. The fibronectin-treated substrates were then incubated with primary antibody (1:100, human anti-fibronectin produced in rabbit, Sigma-Aldrich F3648) in 1×PBS on a shaker overnight at 4° C. Next, the substrates were treated with secondary antibody (1:250, goat anti-rabbit Alexa Fluor 488, Abcam ab150077) diluted in 1×PBS for 1 h on a shaker at 4° C. The substrates were rinsed with 1×PBS and dried with N₂. All the substrates were imaged using a fluorescence microscopy.

### Cell Culture and Shape Engineering

Following PPL patterning of TA-Fe ink solutions, the patterned substrates were treated with oxygen plasma for 30 s at 30 W to remove excess 1-dodecanethiol in the background. Next, the substrates underwent the overnight treatment of ammonium vapor to form covalently crosslinked networks. The unpatterned areas were backfilled with 1 mM MUHEG in ethanol for 30 min followed by ethanol rinsing and PBS washing. Finally, the substrates were placed in 6 well plates containing 25 μg mL⁻¹ fibronectin in 1×PBS and incubated overnight on a shaker at 4° C. and 80 rpm. After fibronectin incubation, the substrates were washed with 1×PBS and were ready for cell adherence. The NIH 3T3 fibroblast cells (ATCC) were cultured at 37° C. in DMEM supplemented with 10% fetal bovine serum (ATLANTA biologicals) and 1% pen strep (gibco) with 5% CO₂. After cell seeding and incubation for 24 h, the pattern cells were fixed with 4% formaldehyde for 10 min, followed by permeabilization with 0.1% Triton-X for 15 min and washing with 1×PBS for three times. Next, the cell pattern substrates were blocked with 1% BSA in 1×PBS for 1 h at RT. The substrates were further incubated with rabbit anti-myosin 11a (Rabbit polyclonal to non-muscle Myosin IIA, Abcam ab75590) on a shaker overnight at 4° C. and 80 rpm. Following treatment with primary antibody, the substrates were treated with secondary antibody (1:1000, goat anti-rabbit Alexa Fluor 647, Invitrogen A32733) diluted in 1×PBS for 1 hr. Prolong Gold Antifade mountant with DAPI (Invitrogen) was used to mount the substrates onto the coverslips for visualization using SP8 immunofluorescence microscopy.

### DNA Synthesis and Purification

Oligonucleotide sequences were carefully designed for the assembly experiments prior to synthesis (Table 1). Oligonucleotides were synthesized on a Mermade 12 (MM12) DNA synthesizer. After synthesis, the oligonucleotides were cleaved from the controlled pore glass (CPG) beads using a solution containing a 1:1 volume mixture of 30% ammonium hydroxide and 40% aqueous methylamine solution (incubation at 55° C. for 30 min). After evaporation, all the oligonucleotides were purified using reverse-phase high performance liquid chromatography (RP-HPLC) on a Varian Microsorb C18 column (10 μm, 300×10 mm). Then, the oligonucleotides were treated with acetic acid solution and ethyl acetate solutions to remove the DMT functional groups. After synthesis and purification, all oligonucleotides were characterized by matrix-assisted laser desorption ionization time-of-flight mass spectrometry (MALDI-TOF-MS) to confirm their molecular mass and purity.

TABLE 1
DNA sequences (anchor and linker strands)
used for the functionalization and
assembly of Au nanoparticles (NPs) on patterns.

| DNA Type | Sequences | SEQ ID NO. |
|---|---|---|
| Anchor | 5′ TCA ACT ATT CCT ACC | SEQ ID |
| strand A | TAC AAA AAA A-SH 3′ | No. 2 |
| Anchor | 5′ TCC ACT CAT ACT CAG | SEQ ID |
| strand B | CAA AAA AAA A-SH 3′ | No. 3 |
| Linker A | 5′ GTA GGT AGG AAT AGT | SEQ ID |
| (L_{A}) | TGA A TTCCTT 3′ | No. 4 |
| Linker B | 5′ TTG CTG AGT ATG AGT | SEQ ID |
| (L_{B}) | GGA A AAGGAA 3′ | No. 5 |

### Synthesis of Au NPs

Spherical Au NPs were synthesized via a seed-mediated approach. Briefly, 0.6 mL ice-cold NaBH₄ (10 mM) was rapidly injected to a pre-prepared solution containing 10 ml of an aqueous solution containing HAuCl₄ (0.25 mM) and CTAB (100 mM) under rigorous stirring at 28° C. The resulting light brown solution was kept at 28° C. for 2 hours. Subsequently, 3 μL seed solution was added to 25 mL of pre-mixed solution containing HAuCl₄ (0.04 mM), CTAB (16 mM) and ascorbic acid (AA, 6 mM). The reaction mixture was left undisturbed at 30° C. overnight, and a light purple colloidal solution (containing small Au octahedron) was achieved. The colloidal solution was used as a seed solution for further growth of bigger Au particles without further treatment.

To synthesize large spherical NPs, 10 μL octahedral seed solution was added to a growth solution obtained by mixing 10 mL cetylpyridinium chloride (CPC, 100 mM), 200 UL HAuCl₄ (25 mM), and 800 μL AA solutions. The size of spherical NPs can be tuned by changing the amount of seed solution added.

### DNA Functionalization and Site-Specific Assembly of Au Spherical NPs

Au NPs were functionalized with anchor DNA A (Table 1) following a literature procedure.⁶⁻⁷ First, 3′-propylthiol-terminated anchor strands were incubated with 100 mM dithiothreitol (DTT) at room temperature for 1 h to cleave the disulfide end. Then, the DTT was removed via size-exclusion chromatography with an NAP25 Column (GE Healthcare). Afterwards, the anchor strands were added to the NP suspensions (~10 nmol DNA per mL of Au NPs), and 1 wt % sodium dodecyl sulfate (SDS) and 1 M sodium phosphate (pH=7.5) were added to reach final concentrations of 0.01 wt % SDS and 10 mM sodium phosphate, respectively. Next, stepwise additions of 5 M NaCl solution (with each aliquot raising the total NaCl concentration by approximately 0.1 M) were added to the solution until it reached a final concentration of 0.5 M NaCl; each addition was followed by 30 s of sonication. This solution was shaken overnight to maximize DNA loading. Excess DNA strands were removed by three rounds of centrifugation/supernatant removal/resuspension. After the final centrifugation step, the anchor-coated NPs were redispersed in a PBS solution (0.5 M NaCl with 0.01 wt % SDS and 10 mM sodium phosphate buffer).

The procedure for DNA functionalization of the TA-Fe nanopatterns fabricated by DPN was similar to that for the NPs as described above. Specifically, 5 nmol of DTT-cleaved anchor DNA A or B in water was used to incubate each substrate. However, instead of stepwise addition of NaCl, the substrates were directly brought to 0.5 M NaCl in one addition, and then shook overnight at 700 rpm. The substrates were then rinsed three times with water and placed in a PBS solution.

After functionalization of thiolated DNA strands, linker strands (L_{A} and L_{B}; Table 1) were hybridized to the two types of substrates, where L_{A} specifically binds with anchor A, and L_{B} with anchor B. And linker strands (L_{A}; Table 1) were hybridized to the NPs functionalized with anchor A. To determine the appropriate number of linkers, the concentration of the NP solution was measured using UV-vis. Subsequently, 10000 strands of linkers were added per NP. Substrates were incubated in a solution containing 0.5×10⁻⁶ M linker. Both the substrates and the NP solutions were then heated to 55° C. for 30 min, and then allowed to slowly cool to room temperature to ensure maximal hybridization between anchor and linker DNA sequences.

Subsequent to the linker hybridization, the patterned substrates were rinsed in PBS solution three times, while NPs were used without further processing. For the assembly of NPs, substrates were first placed in the NP solution and shaken at 1000 rpm overnight (~10 hours) and at 25° C. After assembly, the substrates were rigorously rinsed three times in PBS solutions to remove unbounded NPs. Then the substrates were rinsed three times with 1 M ammonium acetate solutions then blown dried with N₂ for SEM characterization.

### REFERENCES

[1] Eichelsdoerfer, D. J.; Liao, X.; Cabezas, M. D.; Morris, W.; Radha, B., et al., Nat Protoc 2013, 8, 2548-2560.
[2] Chai, J. A.; Huo, F. W.; Zheng, Z. J.; Giam, L. R.; Shim, W., et al., Proc Natl Acad Sci USA 2010, 107, 20202-20206.
[3] Chen, P. C.; Liu, G. L.; Zhou, Y.; Brown, K. A.; Chernyak, N., et al., J Am Chem Soc 2015, 137, 9167-9173.
[4] Shen, H.; Duan, C. T.; Guo, J.; Zhao, N.; Xu, J., J Mater Chem A 2015, 3, 16663-16669.
[5] Xu, Z. Q.; Wang, X. H.; Liu, X. M.; Cui, Z. D.; Yang, X. J., et al., ACS Appl Mater Inter 2017, 9, 39657-39671.
[6] Sun, L.; Lin, H. X.; Li, Y. W.; Zhou, W. J.; Du, J. S. S., et al., Adv Mater 2020, 32, 2005316.
[7] Macfarlane, R. J.; Lee, B.; Jones, M. R.; Harris, N.; Schatz, G. C., et al., Science 2011, 334, 204-208.
1. Liu, M. J.; Wang, S. T.; Jiang, L., Nature-inspired superwettability systems. Nat Rev Mater 2017, 2, 17036.
2. Wang, D. H.; Sun, Q. Q.; Hokkanen, M. J.; Zhang, C. L.; Lin, F. Y.; Liu, Q.; Zhu, S. P.; Zhou, T. F.; Chang, Q.; He, B.; Zhou, Q.; Chen, L. Q.; Wang, Z. K.; Ras, R. H. A.; Deng, X., Design of robust superhydrophobic surfaces. Nature 2020, 582, 55-59.
3. Kim, D. H.; Lee, H.; Lee, Y. K.; Nam, J. M.; Levchenko, A., Biomimetic Nanopatterns as Enabling Tools for Analysis and Control of Live Cells. Adv Mater 2010, 22, 4551-4566.
4. Lee, K. B.; Lim, J. H.; Mirkin, C. A., Protein nanostructures formed via direct-write dip-pen nanolithography. J Am Chem Soc 2003, 125, 5588-5589.
5. Cabezas, M. D.; Meckes, B.; Mirkin, C. A.; Mrksich, M., Subcellular Control over Focal Adhesion Anisotropy, Independent of Cell Morphology, Dictates Stem Cell Fate. ACS Nano 2019, 13, 11144-11152.
6. Tinazli, A.; Piehler, J.; Beuttler, M.; Guckenberger, R.; Tampe, R., Native protein nanolithography that can write, read and erase. Nat Nanotechnol 2007, 2, 220-225.
7. Rosi, N. L.; Mirkin, C. A., Nanostructures in biodiagnostics. Chem Rev 2005, 105, 1547-1562.
8. Barrow, S. J.; Funston, A. M.; Wei, X. Z.; Mulvaney, P., DNA-directed self-assembly and optical properties of discrete 1D, 2D and 3D plasmonic structures. Nano Today 2013, 8, 138-167.
9. Smith, R. K.; Lewis, P. A.; Weiss, P. S., Patterning self-assembled monolayers. Prog Surf Sci 2004, 75, 1-68.
10. Chen, C. J.; Xie, Z.; Wei, X. L.; Zheng, Z. J., Arbitrary and Parallel Nanofabrication of 3D Metal Structures with Polymer Brush Resists. Small 2015, 11, 6013-6017.
11. Chen, C. J.; Zhou, X. C.; Xie, Z.; Gao, T. T.; Zheng, Z. J., Construction of 3D Polymer Brushes by Dip-Pen Nanodisplacement Lithography: Understanding the Molecular Displacement for Ultrafine and High-Speed Patterning. Small 2015, 11, 613-621.
12. Chen, T.; Amin, I.; Jordan, R., Patterned polymer brushes. Chem Soc Rev 2012, 41, 3280-3296.
13. Xu, L. Q.; Neoh, K. G.; Kang, E. T., Natural polyphenols as versatile platforms for material engineering and surface functionalization. Prog Polym Sci 2018, 87, 165-196.
14. Zhou, J. J.; Lin, Z. X.; Ju, Y.; Rahim, M. A.; Richardson, J. J.; Caruso, F., Polyphenol-Mediated Assembly for Particle Engineering. Acc Chem Res 2020, 53, 1269-1278.
15. Sileika, T. S.; Barrett, D. G.; Zhang, R.; Lau, K. H. A.; Messersmith, P. B., Colorless Multifunctional Coatings Inspired by Polyphenols Found in Tea, Chocolate, and Wine. Angew Chem Int Ed 2013, 52, 10766-10770.
16. Rahim, M. A.; Kristufek, S. L.; Pan, S. J.; Richardson, J. J.; Caruso, F., Phenolic Building Blocks for the Assembly of Functional Materials. Angew Chem Int Ed 2019, 58, 1904-1927.
17. Wu, D.; Zhou, J. J.; Creyer, M. N.; Yim, W.; Chen, Z.; Messersmith, P. B.; Jokerst, J. V., Phenolic-enabled nanotechnology: versatile particle engineering for biomedicine. Chem Soc Rev 2021, 50, 4432-4483.
18. Guo, Y. X.; Sun, Q.; Wu, F. G.; Dai, Y. L.; Chen, X. Y., Polyphenol-Containing Nanoparticles: Synthesis, Properties, and Therapeutic Delivery. Adv Mater 2021, 33, 2007356.
19. Lee, H. A.; Ma, Y. F.; Zhou, F.; Hong, S.; Lee, H., Material-Independent Surface Chemistry beyond Polydopamine Coating. Acc Chem Res 2019, 52, 704-713.
20. Ejima, H.; Richardson, J. J.; Caruso, F., Metal-phenolic networks as a versatile platform to engineer nanomaterials and biointerfaces. Nano Today 2017, 12, 136-148.
21. Ejima, H.; Richardson, J. J.; Liang, K.; Best, J. P.; van Koeverden, M. P.; Such, G. K.; Cui, J. W.; Caruso, F., One-Step Assembly of Coordination Complexes for Versatile Film and Particle Engineering. Science 2013, 341, 154-157.
22. Guo, J. L.; Ping, Y.; Ejima, H.; Alt, K.; Meissner, M.; Richardson, J. J.; Yan, Y.; Peter, K.; von Elverfeldt, D.; Hagemeyer, C. E.; Caruso, F., Engineering Multifunctional Capsules through the Assembly of Metal-Phenolic Networks. Angew Chem Int Ed 2014, 53, 5546-5551.
23. Guo, J. L.; Tardy, B. L.; Christofferson, A. J.; Dai, Y. L.; Richardson, J. J.; Zhu, W.; Hu, M.; Ju, Y.; Cui, J. W.; Dagastine, R. R.; Yarovsky, I.; Caruso, F., Modular assembly of superstructures from polyphenol-functionalized building blocks. Nat Nanotechnol 2016, 11, 1105-1111.
24. Lin, Z. X.; Zhou, J. J.; Cortez-Jugo, C.; Han, Y. Y.; Ma, Y. T.; Pan, S. J.; Hanssen, E.; Richardson, J. J.; Caruso, F., Ordered Mesoporous Metal-Phenolic Network Particles. J Am Chem Soc 2020, 142, 335-341.
25. Chen, J. Q.; Pan, S. J.; Zhou, J. J.; Lin, Z. X.; Qu, Y. J.; Glab, A.; Han, Y. Y.; Richardson, J. J.; Caruso, F., Assembly of Bioactive Nanoparticles via Metal-Phenolic Complexation. Adv Mater 2022, 34, 2108624.
26. Fan, G.; Wasuwanich, P.; Rodriguez-Otero, M. R.; Furst, A. L., Protection of Anaerobic Microbes from Processing Stressors Using Metal-Phenolic Networks. J Am Chem Soc 2022, 144, 2438-2443.
27. Guo, J. L.; Suastegui, M.; Sakimoto, K. K.; Moody, V. M.; Xiao, G.; Nocera, D. G.; Joshi, N. S., Light-driven fine chemical production in yeast biohybrids. Science 2018, 362, 813-816.
28. Park, J. H.; Kim, K.; Lee, J.; Choi, J. Y.; Hong, D.; Yang, S. H.; Caruso, F.; Lee, Y.; Choi, I. S., A Cytoprotective and Degradable Metal-Polyphenol Nanoshell for Single-Cell Encapsulation. Angew Chem Int Ed 2014, 53, 12420-12425.
29. Lin, Z. X.; Zhou, J. J.; Qu, Y. J.; Pan, S. J.; Han, Y. Y.; Lafleur, R. P. M.; Chen, J. Q.; Cortez-Jugo, C.; Richardson, J. J.; Caruso, F., Luminescent Metal-Phenolic Networks for Multicolor Particle Labeling. Angew Chem Int Ed 2021, 60, 24968-24975.
30. Zhao, Z. M.; Pan, D. C.; Qi, Q. M.; Kim, J.; Kapate, N.; Sun, T.; Shields, C. W.; Wang, L. L. W.; Wu, D.; Kwon, C. J.; He, W.; Guo, J. L.; Mitragotri, S., Engineering of Living Cells with Polyphenol-Functionalized Biologically Active Nanocomplexes. Adv Mater 2020, 32, 2003492.
31. Pan, S. J.; Guo, R.; Bertleff-Zieschang, N.; Li, S. S.; Besford, Q. A.; Zhong, Q. Z.; Yun, G.; Zhang, Y. T.; Cavalieri, F.; Ju, Y.; Goudeli, E.; Richardson, J. J.; Caruso, F., Modular Assembly of Host-Guest Metal-Phenolic Networks Using Macrocyclic Building Blocks. Angew Chem Int Ed 2020, 59, 275-280.
32. Luo, W.; Xiao, G.; Tian, F.; Richardson, J. J.; Wang, Y. P.; Zhou, J. F.; Guo, J. L.; Liao, X. P.; Shi, B., Engineering robust metal-phenolic network membranes for uranium extraction from seawater. Energ Environ Sci 2019, 12, 607-614.
33. Guardingo, M.; Gonzalez-Monje, P.; Novio, F.; Bellido, E.; Busque, F.; Molnar, G.; Bousseksou, A.; Ruiz-Molina, D., Synthesis of Nanoscale Coordination Polymers in Femtoliter Reactors on Surfaces. ACS Nano 2016, 10, 3206-3213.
34. Piner, R. D.; Zhu, J.; Xu, F.; Hong, S. H.; Mirkin, C. A., “Dip-pen” nanolithography. Science 1999, 283, 661-663.
35. Huo, F. W.; Zheng, Z. J.; Zheng, G. F.; Giam, L. R.; Zhang, H.; Mirkin, C. A., Polymer pen lithography. Science 2008, 321, 1658-1660.
36. Liu, G. Q.; Petrosko, S. H.; Zheng, Z. J.; Mirkin, C. A., Evolution of Dip-Pen Nanolithography (DPN): From Molecular Patterning to Materials Discovery. Chem Rev 2020, 120, 6009-6047.
37. Fang, L. Y.; Zhang, J. H.; Chen, Y. C.; Liu, S. L.; Chen, Q. Y.; Ke, A.; Duan, L. T.; Huang, S. L.; Tian, X. L.; Xie, Z., High-Resolution Patterned Functionalization of Slippery “Liquid-Like” Brush Surfaces via Microdroplet-Confined Growth of Multifunctional Polydopamine Arrays. Adv Funct Mater 2021, 31, 2100447.
38. Rahim, M. A.; Bjornmalm, M.; Bertleff-Zieschang, N.; Besford, Q.; Mettu, S.; Suma, T.; Faria, M.; Caruso, F., Rust-Mediated Continuous Assembly of Metal-Phenolic Networks. Adv Mater 2017, 29, 1606717.
39. Yun, G.; Besford, Q. A.; Johnston, S. T.; Richardson, J. J.; Pan, S. J.; Biviano, M.; Caruso, F., Self-Assembly of Nano- to Macroscopic Metal-Phenolic Materials. Chem Mater 2018, 30, 5750-5758.
40. Bjornmalm, M.; Cui, J. W.; Berdeff-Zieschang, N.; Song, D. Z.; Faria, M.; Rahim, M. A.; Caruso, F., Nanoengineering Particles through Template Assembly. Chem Mater 2017, 29, 289-306.
41. Fan, H. L.; Wang, L.; Feng, X. D.; Bu, Y. Z.; Wu, D. C.; Jin, Z. X., Supramolecular Hydrogel Formation Based on Tannic Acid. Macromolecules 2017, 50, 666-676.
42. Chai, J.; Liao, X.; Giam, L. R.; Mirkin, C. A., Nanoreactors for Studying Single Nanoparticle Coarsening. J Am Chem Soc 2012, 134, 158-161.
43. Du, J. S.; Chen, P. C.; Meckes, B.; Kluender, E. J.; Xie, Z.; Dravid, V. P.; Mirkin, C. A., Windowless Observation of Evaporation-Induced Coarsening of Au—Pt Nanoparticles in Polymer Nanoreactors. J Am Chem Soc 2018, 140, 7213-7221.
44. Chai, J. A.; Huo, F. W.; Zheng, Z. J.; Giam, L. R.; Shim, W.; Mirkin, C. A., Scanning probe block copolymer lithography. Proc Natl Acad Sci USA 2010, 107, 20202-20206.
45. Chen, P. C.; Liu, X. L.; Hedrick, J. L.; Xie, Z.; Wang, S. Z.; Lin, Q. Y.; Hersam, M. C.; Dravid, V. P.; Mirkin, C. A., Polyelemental nanoparticle libraries. Science 2016, 352, 1565-1569.
46. Chen, P. C.; Liu, G. L.; Zhou, Y.; Brown, K. A.; Chernyak, N.; Hedrick, J. L.; He, S.; Xie, Z.; Lin, Q. Y.; Dravid, V. P.; O'Neill-Slawecki, S. A.; Mirkin, C. A., Tip-Directed Synthesis of Multimetallic Nanoparticles. J Am Chem Soc 2015, 137, 9167-9173.
47. Chernousova, S.; Epple, M., Silver as Antibacterial Agent: Ion, Nanoparticle, and Metal. Angew Chem Int Ed 2013, 52, 1636-1653.
48. Xiu, Z. M.; Zhang, Q. B.; Puppala, H. L.; Colvin, V. L.; Alvarez, P. J. J., Negligible Particle-Specific Antibacterial Activity of Silver Nanoparticles. Nano Lett 2012, 12, 4271-4275.
49. Zhang, L.; Wu, J. J.; Wang, Y. X.; Long, Y. H.; Zhao, N.; Xu, J., Combination of Bioinspiration: A General Route to Superhydrophobic Particles. J Am Chem Soc 2012, 134, 9879-9881.
50. Ham, H. O.; Liu, Z. Q.; Lau, K. H. A.; Lee, H.; Messersmith, P. B., Facile DNA Immobilization on Surfaces through a Catecholamine Polymer. Angew Chem Int Ed 2011, 50, 732-736.
51. Chen, C. J.; Ng, D. Y. W.; Weil, T., Polymer bioconjugates: Modern design concepts toward precision hybrid materials. Prog Polym Sci 2020, 105, 101241.
52. Eichelsdoerfer, D. J.; Liao, X.; Cabezas, M. D.; Morris, W.; Radha, B.; Brown, K. A.; Giam, L. R.; Braunschweig, A. B.; Mirkin, C. A., Large-area molecular patterning with polymer pen lithography. Nat Protoc 2013, 8, 2548-2560.
53. Lang, S. Y.; Chen, C. J.; Xiang, J.; Liu, Y. Q.; Li, K. J.; Hu, S.; Liu, G. Y., Facile and Robust Antibacterial Functionalization of Medical Cotton Gauze with Gallic Acids to Accelerate Wound Healing. Ind Eng Chem Res 2021, 60, 10225-10234.
54. Giam, L. R.; Massich, M. D.; Hao, L. L.; Wong, L. S.; Mader, C. C.; Mirkin, C. A., Scanning probe-enabled nanocombinatorics define the relationship between fibronectin feature size and stem cell fate. Proc Natl Acad Sci USA 2012, 109, 4377-4382.
55. Lin, M.; Meckes, B.; Chen, C. J.; Teplensky, M. H.; Mirkin, C. A., Controlling Intracellular Machinery via Polymer Pen Lithography Molecular Patterning. Acs Central Sci 2022, 8, 1282-1289.
56. Mirkin, C. A.; Letsinger, R. L.; Mucic, R. C.; Storhoff, J. J., A DNA-based method for rationally assembling nanoparticles into macroscopic materials. Nature 1996, 382, 607-609.
57. Jones, M. R.; Seeman, N. C.; Mirkin, C. A., Programmable materials and the nature of the DNA bond. Science 2015, 347, 1260901.
58. Li, Y.; Zhou, W.; Tanriover, I.; Hadibrata, W.; Partridge, B. E.; Lin, H.; Hu, X.; Lee, B.; Liu, J.; Dravid, V. P.; Aydin, K.; Mirkin, C. A., Open-channel metal particle superlattices. Nature 2022, 611, 695-701.
59. Cutler, J. I.; Auyeung, E.; Mirkin, C. A., Spherical Nucleic Acids. J Am Chem Soc 2012, 134, 1376-1391.
60. Zhang, C.; Macfarlane, R. J.; Young, K. L.; Choi, C. H. J.; Hao, L. L.; Auyeung, E.; Liu, G. L.; Zhou, X. Z.; Mirkin, C. A., A general approach to DNA-programmable atom equivalents. Nat Mater 2013, 12, 741-746.
61. Macfarlane, R. J.; O'Brien, M. N.; Petrosko, S. H.; Mirkin, C. A., Nucleic Acid-Modified Nanostructures as Programmable Atom Equivalents: Forging a New “Table of Elements”. Angew Chem Int Ed 2013, 52, 5688-5698.
62. Greybush, N. J.; Liberal, I.; Malassis, L.; Kikkawa, J. M.; Engheta, N.; Murray, C. B.; Kagan, C. R., Plasmon Resonances in Self-Assembled Two-Dimensional Au Nanocrystal Metamolecules. ACS Nano 2017, 11, 2917-2927.
63. Shin, M.; Ryu, J. H.; Park, J. P.; Kim, K.; Yang, J. W.; Lee, H., DNA/Tannic Acid Hybrid Gel Exhibiting Biodegradability, Extensibility, Tissue Adhesiveness, and Hemostatic Ability. Adv Funct Mater 2015, 25, 1270-1278.

What is claimed is:

1. A method for patterning metal-phenolic networks on a substrate, comprising:
patterning a precursor ink on the substrate to form a pattern of discrete precursor features, wherein the precursor ink comprises a polyphenol and one or more metal ions, and the polyphenol has three or more phenolic groups; and
exposing the pattern of discrete precursor features to a vapor from a volatile base to thereby convert the pattern of discrete precursor features to a pattern of discrete metal-phenolic network features.

2. The method of claim 1, further comprising functionalizing the pattern of discrete metal-phenolic network features with a biomolecule.

3. The method of claim 2, wherein the biomolecule is a peptide, protein, DNA, RNA, and/or oligonucleotide.

4. A method of forming metal nanostructures, comprising:
patterning a precursor ink on a substrate to form a pattern of discrete precursor features, wherein the precursor ink comprises a polyphenol and one or more metal ions, and the polyphenol has three or more phenolic groups; and
annealing the pattern of discrete precursor features in a reducing environment to form the metal nanostructures, wherein the pattern of discrete precursor features is a nanoreactor for the conversion of the metal ions in the precursor ink to the metal nanostructures during annealing.

5. The method of claim 4, wherein a ratio of polyphenol to metal ion in the precursor ink is about 1:1 to about 20:1, preferably about 2:1.

6. A method of forming metal nanostructures, comprising:
patterning a precursor ink on a substrate to form a pattern of discrete precursor features, wherein the precursor ink comprises a polyphenol and one or more metal ions, and the polyphenol has 3 or more phenolic groups;
exposing the pattern of discrete precursor features to a vapor from a volatile base to thereby convert the pattern of discrete precursor features to a pattern of discrete metal-phenolic network features; and
immersing the pattern of discrete metal-phenolic network features in a metal-ion solution comprising one or more metal ions, whereby the one or more metal ions in the metal-ion solution is reduced to form the metal nanostructures.

7. The method of claim 6, wherein the metal-ion solution comprises metal ions selected from one or more of Au³⁺, Ag⁺, and Pd²⁺.

8. A method of writing and rewriting a surface comprising metal-phenolic network features, comprising:
patterning a first precursor ink on a substrate ions to form a first pattern of discrete precursor features, wherein the precursor ink comprises a polyphenol and one or more metal, and the polyphenol has 3 or more phenolic groups;
exposing the first pattern of discrete precursor features to a first vapor from a volatile base to thereby convert the first pattern of discrete precursor features to a first pattern of discrete metal-phenolic network features;
exposing the first pattern of discrete metal-phenolic network features to an acid solution to erase the first pattern of discrete metal-phenolic network features; and
rewriting the substrate with a second pattern of discrete metal-phenolic network features by repeating the patterning with a second precursor ink to form a second pattern of discrete precursor features and exposing the second pattern of discrete precursor features to a second vapor from a volatile base to thereby convert the second pattern of discrete precursor features to the second pattern of metal-phenolic network features.

9. The method of claim 8, wherein the acid solution contains one or more of HCl, H₂SO₄, HNO₃, and H₂CO₃.

10. The method of claim 8 or 9, wherein the first pattern of discrete precursor features has a pattern shape and/or size different than the second pattern of discrete precursor features.

11. The method of any one of claims 8 to 10, wherein the first precursor ink comprises one or both of a different metal ion and polyphenol as compared to the second precursor ink.

12. The method of any one of claims 8 to 10, wherein the first precursor ink is the same as the second precursor ink.

13. The method of any one of claims 8 to 12, wherein the first vapor is different than the second vapor.

14. The method of any one of claims 8 to 12, wherein the first vapor is the same as the second vapor.

15. The method of any one of the preceding claims, wherein the one or more metal ions is from a metal selected from one or more of Fe, Co, Ni, Cu, Zn, Al, V, Cr, Mn, Cd, Gd, Tb, Ce, Eu, Mo, Rh, and Ru

16. The method of any one of the preceding claims, wherein the metal ions are provided as a metal precursor.

17. The method of claim 16, wherein the metal precursor is a metal salt.

18. The method of claim 17, wherein the metal salt is one or more of FeCl₃, Co(NO₃)₂, NiCl₂, Cu(NO₃)₂, Zn(NO₃)₂, and MnCl₂.

19. The method of any one of the preceding claims, wherein the polyphenol can include catechol and/or galloyl groups.

20. The method of any one of the preceding claims, wherein the polyphenol is one or more of tannic acid (TA), gallic acid (GA), epicatechin gallate (ECG), epigallocatechin gallate (EGCG), theaflavin-3′-gallate, and castalagin.

21. The method of any one of the preceding claims, wherein the substrate is hydrophobic or has a hydrophobic surface onto which the precursor ink is deposited.

22. The method of any one of the preceding claims, wherein the precursor ink comprises one or more different metal ions.

23. The method of any one of the preceding claims, wherein the precursor ink comprises two or more polyphenols each with different numbers of catechol and/or galloyl groups.

24. The method of any one of the preceding claims, wherein the volatile base is one or more of ammonia, hydrazine, methylamine, ethylamine, diethylamine, and triethylamine.
